(19) United States
(12) Patent Application Publication
(10) Pub. No.: US 2012/0175077 A1
(43) Pub. Date: Jul. 12, 2012

(54) Geothermal Heat Exchanger

(76) Inventors: Reijer Willem Lehmann, Lopik (NL); Jacob Lehmann, Lopik (NL)

(21) Appl. No.: 13/315,655

(22) Filed: Dec. 9, 2011

Related U.S. Application Data
(63) Continuation-in-part of application No. PCT/NL2009/000253, filed on Dec. 15, 2009.
Application No. PCT/NL2009/000253 is a continuation-in-part of application No. PCT/NL2011/000024, filed on May 4, 2011.

(30) Foreign Application Priority Data
Jun. 9, 2009 (EP) 09.007 590.4
Apr. 6, 2010 (NL) 1037860
Apr. 14, 2010 (NL) 1037890

(51) Int. Cl. F24J 3/08; B29C 47/00; B23P 19/04

(52) U.S. Cl. 165/45; 29/428; 264/177.1

(57) ABSTRACT

A geothermal heat exchanger, comprising an inner tube bounding a first passage for a flowing heat exchanger fluid. The inner tube has one or more ribs on an outer side thereof. The inner tube and the one or more ribs are integrally formed by extrusion and entirely made of a thermally-insulating synthetic foamed material. The geothermal heat exchanger further comprises an outer tube made of thermally-conductive material concentrically positioned around the inner tube. The one or more ribs abut a first surface of the outer tube, and the inner tube and the outer tube cooperate to define an annular space which forms a second passage for the flowing heat exchanger fluid.

### CROSS-REFERENCE TO RELATED APPLICATIONS

This application claims priority and benefit under 35 U.S.C. §120 and 35 U.S.C. §365(c) as a continuation-in-part of International Application PCT/NL2009/000253 which was assigned an international filing date of Dec. 15, 2009 and associated with publication WO2011/005075 and which claims priority under 35 U.S.C. §365(b) to a European Patent Application No. 09.007590.4 filed on Jun. 9, 2009, the disclosures of which are hereby expressly incorporated herein by reference in their entirety. This application further claims priority and benefit under 35 U.S.C. §120 and 35 U.S.C. §365(c) as a continuation-in-part of International Application PCT/NL2011/000024 which was assigned an international filing date of May 4, 2011 and associated with publication WO2011/126359, and which claims priority under 35 U.S.C. §365(b) to a Netherlands Patent Application No. 1037860 filed on Apr. 6, 2010, and to a Netherlands Patent Application No. 1037890 filed on Apr. 14, 2010, the disclosures of which are hereby expressly incorporated herein by reference in their entirety.

### BACKGROUND

The invention relates to a heat exchanger to be incorporated in a bottom. The invention furthermore relates to a heat pumping plant having such a heat exchanger. The invention further relates to a building, such as a house, office building, factory, greenhouse or hothouse, provided with such a heat pumping plant.

Heat exchangers to be incorporated in a bottom are known in many embodiments. An example is described in international patent application WO 00/36343, in which in a bore hole that is over 50 meters deep, a free inner pipe enveloped by a hose of insulation material, is lowered, as well a casing built up from vertical channels. At the lower end the channels merge via a manifold into a smaller number of connecting channels that are connected to the lower end of the inner pipe. The space between the casing and the inner pipe is filled with ground water.

In another known embodiment an assembly built up from two HDPE pipes/tubes that are placed against each other and are connected to each other is lowered into a bore hole, which pipes/tubes at the lower end merge into each other into an end piece, so that a kind of loop is formed. In an alternative embodiment shown in GB-A-2,443,954, the lower end of the assembly is urged into the bottom simultaneously with a drill head.

Due to traversing cold soil layers geothermal heat exchangers usually are filled with a glycol-containing liquid. The longer the line, the greater the risk of leakage, particularly where there are couplings. Leakage of glycol may be disadvantageous in layers the ground water of which is intended to be drinking water. The thermal influence on ground water intended to be drinking water may also be undesirable. In case of long lines, which also require a high pumping capacity, a mutual thermal influence may furthermore become important, especially when both lines are situated right next to each other, as a result of which the efficiency is affected negatively. A further drawback of long lines is that the introduction into the bottom requires corresponding effort and time.

The invention further relates to introducing an elongated element into a soil, such as a heat exchanger or terrestrial heat probe, drainage pipe, exploration pipe (to be connected to a well), a gas supply line and a gas extraction line (for instance for soil sanitation or monitoring, seismic pipes, pull anchors etc.).

By way of example geothermal applications will be gone into here. Geothermal relative heat or relative cold is increasingly used in climate regulation of buildings and infrastructural facilities. Such systems usually comprise an elongated heat exchanger that extends from a soil surface into the soil, down to a certain depth for contact and temperature exchange with the wanted soil strata.

In a known process a drill tube is drilled into the soil from the surface level using drilling gear, while circulating a water/bentonite mixture for discharging soil material. After the desired depth has been reached the drill tube with drill head is retrieved, whereas the water/bentonite mixture keeps on being supplied. Subsequently the heat exchanger is lowered in the filled borehole, for which purpose its lower end is weighted by attaching a weight thereto so that the heat exchanger is pulled into the soil as it were.

This process is rather uncontrolled. It may occur that the borehole wall locally subsides as a result of locally higher hydraulic pressure. Furthermore the lowering of the heat exchanger in inclined boreholes can be made difficult by the weight getting into contact with the borehole wall. The heat exchanger can also get damaged.

Similar problems are also experienced in the other applications mentioned in the preamble.

### SUMMARY

It is an object of the inventive concepts disclosed herein to provide a geothermal heat exchanger, with which increased efficiency can be achieved.

It is an object of the invention to provide a geothermal heat exchanger, with which adversely influencing the surroundings in the bottom can be limited.

It is an object of the invention to provide a geothermal heat exchanger, of which the length can be kept limited while retaining or increasing efficiency.

It is an object of the invention to provide a geothermal heat exchanger that can be installed in a bottom within a short period of time.

At least one of these objects can be achieved according to the invention using a tube assembly for a heat exchanger active in the ground, comprising a first tube having an axis, which tube forms a first passage for a heat exchanger fluid flowing therethrough, particularly a liquid, particularly water, and a second tube having an axis, wherein the first tube while forming an annular space, which forms a second passage for the heat exchanger fluid flowing therethrough, is accommodated in an axial-parallel manner in the second tube, preferably in a concentric manner, wherein the annular space is provided with first spacers for keeping the first tube and the second tube spaced apart from each other all round, wherein the first spacers are provided with directing means for subjecting the fluid flow in the annular space to a tangential flow directional component, wherein the directing means form a helical flow guidance surface with respect to the axis of the first tube, wherein at radial outward distance from the first tube, at or near the inner surface of the second tube, turbulence increasing means for the fluid flow are arranged, preferably in the form of holes in surfaces contacting the flowing fluid.

In such a tube assembly the position of the first tube is fixed with respect to the second tube and in an arrangement as heat exchanger in a ground thus with respect to the ground, and over the length of the tubes it will correspond with the design, so that the achievements of the heat exchanger can be reliable. In case of a concentric position of both tubes, usually the thermal transfer will be substantially equally distributed all round. The helical first spacers moreover make the tube assembly rigid so that it can be introduced into a bottom more easily and more reliably and they ensure an extended flow path as a result of which the contact time of the fluid with the second tube is extended, and thus the duration of thermal transfer is increased. As a result thereof the overall length of the tube assembly can remain limited and the installation can be limited down to a smaller depth. In that way deep (drinking) water guiding layers can remain out of the sphere of influence.

Moreover because of the support given to the second tube by the spacers, the second tube can be designed with a thinner wall, as a result of which with the same outer diameter the second passage can be enlarged, as a result of which the rate of flow therein can be lower and thus the length of stay longer. The turbulence increasing means, which have particularly been arranged regularly distributed over the length and circumference of the tube assembly, particularly in the form of holes in surfaces that limit the flow path in an area at or near the second tube, counteract the formation of a laminar boundary layer at the second tube and then ensure increase of the degree of turbulence, as a result of which the efficiency of the heat exchange through the second tube is further increased and the length and/or diameter of the tube assembly can remain limited. Between the holes and the first tube the flow guidance surface is uninterrupted, so that the flow there is enhanced and the contacting time with the first tube remains limited. This is even further improved when the surface of the first tube bounding the annular space and the flow guidance surface is smooth.

When the turbulence increasing means are formed like holes, they preferably are through-holes in order to form auxiliary passages for the flowing fluid from the upstream side of the spacer to its downstream side, so that a series of second flow paths is provided, which further increases the degree of turbulence. The holes preferably are formed like grooves. The holes preferably extend parallel to the axes of both tubes.

In one advantageous embodiment there are several, individual auxiliary passages, situated distributed. When the auxiliary passages are formed in the spacers the manufacturing of the tube assembly is made easier.

The first tube can be provided with a means for thermal insulation of the first and second passages with respect to each other. In one embodiment the first tube has double walls for that purpose in order to form an intermediate annular space, filled with gas (air) or with an insulation material, wherein intermediate spacers are present between both walls. Such an annular air chamber preferably is closed at its upper end. When the air in the intermediate annular space has absorbed heat from the fluid during its downward flow through the annular space, said heat can at least partially be transferred to the rising fluid in the inner tube, particularly in an upper part thereof.

Alternatively the first tube comprises an inner casing of synthetic foamed material on which the spacers are located. In one embodiment that is easy to manufacture the first spacers are integrally formed with the inner casing, preferably of the same material, preferably by extrusion. The helical shape is then acquired by rotating the extrusion head.

The flow in the first passage and the strength are enhanced when the inner casing is arranged around an inner tube of substantially solid material, preferably by extrusion.

In order to facilitate the shortening of the inner casing, which may be necessary at the lower end of the heat exchanger, the inner tube at the outer surface can be provided with a coating for lowering the adhesive force between the inner tube and the inner casing.

In a further development of the tube assembly according to the invention, considered in a plane of longitudinal section containing the tube axes, the flow guidance surface descends towards the second tube. In that way the fluid is urged to the second tube where the turbulence increasing means are situated.

In one embodiment thereof, wherein the spacers on either side define a flow guidance surface, both surfaces one to the other converge radially to the outside with an opposite sign. The tube assembly can then be used in the same orientation in a system having opposite flow: in both cases the fluid is urged outward. This also has advantages as regards assembly of several consecutive lengths of tubes, as in that case the orientation need not be of importance.

In one embodiment the spacers in their cross-section (that means a cross-section on the spacer, coinciding with an axial plane of cross-section of the tube assembly) have a radial inner side situated at the first tube and a radial outer side situated at the second tube, wherein the radial inner side has a larger length than the radial outer side, wherein the spacers preferably are trapezoidal in cross-section. A consequence thereof is that the contact surface with the first tube is made smaller. Moreover it may improve the supportive action of the spacers for the second tube.

In one embodiment the tube assembly near the upper end thereof is provided with means for heating the fluid flowing out or flowing in, so that a post-heating is given before it reaches a heat pump or an additional or pre-heating when a greater quantity of heat is wanted to be transferred to the ground (for instance to counteract it getting frozen or for enhancing decomposition processes of waste and/or pollutions). The heating means can be placed for heating the fluid flowing through the first tube. They may comprise an envelope of the first tube, which can be electrically activated. The envelope may for that purpose comprise two electrodes, connected to an external power supply, such as a power supply based on wind or solar energy.

When the second tube, considered in longitudinal direction of the tube, has been built up from lengths of different material having different coefficients of heat conduction, the heat exchanger can be adapted to the surrounding soil type. For instance a water-containing sand layer will be able to absorb heat more quickly than a clay layer. The portion of the second tube extending through the sand layer can then be of metal, having a high coefficient of heat conduction, whereas the portion extending through a clay layer can be of synthetic material, such as HDPE, having a lower coefficient of heat conduction. The consecutive lengths can be attached to each other with suitable means, for instance by insertion connections, optionally supplemented by an adhesive.

Thus the invention according to a further aspect provides a tube assembly for a heat exchanger active in the ground, comprising a first tube and a second tube, wherein the first tube while forming an annular space intended for heat exchanger fluid flowing through, is accommodated in the second tube, wherein the first tube is adapted for said fluid flowing through, wherein the second tube considered in longitudinal direction of the tube has been built up from lengths of different material having different coefficients of heat conduction, which lengths are either intended or placed for thermal transfer during use between the annular space and the ground.

According to a further aspect the invention provides a tube, particularly for a tube assembly according to the invention, comprising an inner tube, of substantially solid material and a casing arranged around it of synthetic foamed material, wherein the casing at the outer side is provided with at least one helical rib of synthetic foamed material, preferably of the same material as the casing's material, wherein, preferably, the casing is arranged on the inner tube so as to fit snugly, preferably by extrusion, preferably while applying an anti-adhesive between the inner tube and the casing.

Such a tube is suitable as first tube in a tube assembly according to the invention. In one embodiment the tube is accommodated in an outer tube which in circumferential sense is supported by the rib. Depending on the length of the tube several tubes can be connected to each other in longitudinal direction into a tube assembly of the desired length.

According to a further aspect the invention provides a method for manufacturing a tube assembly comprising an inner tube of substantially solid material and situated thereon a casing of synthetic foamed material, wherein the casing is extruded on the inner tube, wherein the casing is provided with a helical rib, wherein the rib is preferably made of synthetic foamed material, preferably of material equalling the casing's material, wherein, preferably, the casing and the rib are formed simultaneously, wherein, preferably, the rib is made having a trapezoidal cross-section, preferably having side surfaces that incline with respect to a radial surface at that location, preferably having an opposite sign. Preferably through-going recesses, preferably grooves, extending in tube direction are made in the radial outer side of the rib.

The assembly of inner tube and casing arranged thereon thus achieved can be inserted into an outer tube, preferably in a snugly fitting manner. The impressionability of the ribs makes it possible that they press against the inner surface of the outer tube, thus ensuring a proper abutment.

The invention further provides an arrangement of at least one tube assembly according to the invention, arranged in a bottom, wherein the tube assembly extends in the bottom, wherein the tube assembly at the end is provided with a closure, having a space in which the annular space is in fluid connection with the inside of the first tube, wherein the tube assembly at the opposite end is connected to a thermal converter while creating a cycle in which the inside of the first tube and the annular space are included. In one embodiment the thermal converter is formed by a heat source, particularly in an arrangement for heating the bottom, for instance of airports, sports fields or for the said improvement of cleansing processes in the bottom.

The invention furthermore provides a building on a bottom, provided with at least one tube assembly according to the invention arranged in the bottom, wherein the tube assembly extends in the bottom, in one embodiment down to a depth below the building, wherein the tube assembly at the end is provided with a closure, having a space in which the annular space is in fluid connection with the inside of the first tube, wherein the tube assembly at the opposite end is connected to a thermal converter while creating a cycle in which the inside of the first tube and the annular space are included. The building may for instance be a house, business premises, factory hall, greenhouse or hothouse with a series of tube assemblies placed in the bottom spaced apart from each other.

The said (synthetic) foamed material preferably is a foamed material of closed cells. The cell walls of the closed cells increase the strength, advantageous to the support of the second or outer tube, and the closed cell volumes increase the insulating value. The surface of the foamed material contacted by the fluid, at least the part thereof that is radially spaced from the outer tube, preferably is made smooth in order to improve the rate of flow along it. In addition it may opted for to leave the radial outer edge areas untreated in that respect, for some roughness, to improve a turbulent flow near the outer tube.

It is noted that from EP-A-1,486,741 a tube assembly is known for a geothermal heat exchanger, wherein an inner tube is provided with an insulation casing and with it extends within a helical collector tube with which the inner tube forms a cycle. The collector tube is spaced apart from a metal casing that is placed in a bore hole. In a lowermost area the inner tube has a thickened wall and it is surrounded by a heat conducting moulding material, in which also the collector tube is surrounded.

JP-A-2007-139370 shows a tube assembly for a geothermal heat exchanger having an inner tube enveloped by an insulation casing and having an outer tube situated concentrically around it.

It is an object of the invention to provide a method of the type mentioned in the preamble, with which an elongated element, such as for instance a heat exchanger, can be introduced into a soil in a reliable and safe manner, as well as an arrangement for it.

It is an object of the invention to provide a method of the type mentioned in the preamble, with which an elongated element, such as for instance a heat exchanger, can be introduced into a soil in an easy manner, as well as an arrangement for it.

It is an object of the invention to provide a drill head assembly with which the introduction into the soil of a tube coupled thereto is enhanced.

It is an object of the invention to provide a method of the type mentioned in the preamble, with which an elongated element, such as for instance a geothermal heat exchanger, can be introduced into a soil at an inclined angle, as well as the means for it.

It is an object of the invention to provide a concentric tube assembly that is particularly suitable for use in a geothermal heat exchanger. A further object of the invention is providing an inner tube that is particularly suitable for said tube assembly.

It is an object of the invention to provide a simple entrance/exit cap for a concentric tube assembly that is particularly suitable for use in a geothermal heat exchanger.

For achieving at least one of these objects the invention, according to one aspect, provides a method for introducing an elongated element into a soil, such as a tubular geothermal heat exchanger or terrestrial heat probe, comprising the following steps: (a) in a drilling motion introducing a drill tube into the soil, which drill tube for that

purpose has been provided with a drill head at its lower end; (b) during the drilling motion supplying a liquid, particularly a bentonite mixture, through the space within the drill tube; (c) introducing the elongated element in the space within the drill tube; (d) detaching the drill tube from the drill head; and (e) retracting the drill tube while keeping the elongated element in the soil.

In that way the integrity of the borehole during the introduction of the elongated element is ensured. During lowering the elongated element it does not make contact with the borehole wall, but instead at the most with the usually smooth drill tube. This considerably reduces the risk of external damage of the elongated element during the introduction.

In one embodiment, at the location of the drill head, the liquid is allowed to exit via a passage between the inside of the drill tube and the space outside of the drill head, wherein by means of a one-way valve arranged in the passage a flow of liquid from outside of the drill head to the inside of the drill tube is prevented. The one-way valve can be a floating ball or a ball that is biased against the passage, in a proximal direction. In that way it is prevented that during drilling a locally high hydraulic pressure results in groundwater and sand entering, as a result of which flushing holes could otherwise get clogged up.

In one embodiment the liquid is discharged through the drill head via holes in the bit of the drill head, preferably in the immediate vicinity of the bit edge, particularly immediately behind it, considered in drill rotation direction. In that case the holes can open in a substantially forward, distal direction.

In one embodiment before and during uncoupling the liquid is pressurised at a higher level, as a result of which in the uncoupling motion the drill head can be urged axially from the drill tube end and is pressed deeper into the soil. In that way the uncoupling is accelerated and/or the drill head is attached into the soil more firmly.

In one embodiment before completing the introduction of the elongated element, preferably before starting said introduction, the drill tube with drill head is retracted over a certain distance, for instance one meter, so that in front of the drill head a space filled with said liquid is achieved.

At the end of the introduction of the elongated element its lower end can be brought into engagement with the drill head. In that case the lower end of the elongated element can be axially coupled to the drill head, as a result of which the drill head could also be active as anchor for the elongated element during retracting the drill tube. In one embodiment the lower end of the elongated element may also be rotation-fixedly coupled to the drill head, so that retraction of the drill tube is facilitated.

Alternatively the lower end or distal end of the elongated element is provided with an anchor, particularly a tilting anchor, which after retracting the drill tube along it, gets into engagement with the borehole wall.

In a further development of the method according to the invention, prior to and/or during the retraction of the drill tube the liquid used up until then is replaced by a filler of a higher density than the liquid used up until then, particularly a grout mixture. Said filler is selected in view of stability of the borehole after removal of the drill tube and with a view to the function of heat exchanger, favourable thermal conduction coefficient, such as heat-conducting grout having a thermal conduction coefficient of over 0.7, preferably over 2.5.

Preferably during the retraction of the drill tube the filling of the drill tube is kept at overpressure that exceeds the pressure at the lower end of the drill tube, particularly over 20 bar, for instance in the range of 20-60 bar, in which way it is prevented that at the outer end of the drill tube an underpressure arises that jeopardises the stability of the drillhole.

Preferably prior to the retraction of the drill tube, the upper end of the drill tube is closed off by means of a plug, which is provided with a passage for the filler, wherein the passage is connected to a pressure source of filler. Preferably the plug is kept in its place with respect to the elongated element, for which purpose it has been provided with a slide sealing against the drill tube wall.

The filler can be supplied via a drill motor (tube rotary head) engaging onto the upper end of the drill tube, wherein when removing the each time top drill tube section, said drill tube section is uncoupled from the rotary head, the supply of the filler is temporarily ended and after reconnecting the remainder of the drill tube to the rotary head the supply is resumed.

Preferably the drill tube is uncoupled from the drill head by an uncoupling motion of the drill tube comprising a rotary motion counter the drill rotation direction. The uncoupling motion may comprise an axially proximally oriented component, which at least substantially follows the rotary motion.

In a further development of the method according to the invention the introduction of the elongated element takes place by exerting a pushing force thereon, so that the introduction is independent from the angle of the drillhole to the horizontal. The introduction is enhanced when the reactive force for the pushing force is transferred to the drill tube.

In one embodiment the pressure/pusher device is reciprocally moved with an introduction track in which the pressure device engages onto the elongated element and takes it along and a return track in which the pressure device moves back with respect to the elongated element. The pressure device may for that purpose be attached to the drill motor. The pressure device may in that case clampingly engage onto the outside of the elongated element with pressure rollers that can be rotated in one direction only. The elongated element moving back is counteracted when during the return stroke of the pressure device the outside of the elongated element is stopped from moving back. Said stopping of the elongated element from moving back can be carried out using guide rollers that are rotatable in one direction, which guide rollers preferably are positioned stationary with respect to the drill tube.

It is also possible to introduce the elongated element using a pressure/pusher device that is attached to the upper end of the drill tube, wherein the elongated element is guided by rollers attached to the pressure device, wherein at least one of the rollers is driven. Preferably of at least one of the rollers the distance in radial direction is set.

The elongated element can be introduced into the drill tube over its full introducing length as one elongated unity, wherein the elongated element is unrolled from a supply roll.

According to a further aspect the invention provides a drill head assembly for by drilling introducing a drill tube into a soil, comprising a drill head and a drill head holder to be attached to the drill tube, wherein the drill head is provided with a drill bit having cutting edges, wherein the drill head and the drill head holder are provided with first and second cooperating coupling means, respectively, for detachable coupling one to the other, wherein the drill head holder is provided with a stop for the drill bit, which stop is active in a direction opposing the rotation direction of the drill head. In that way an uncoupling of the drill head and drill tube is made possible, whereas also tangential support is offered to the drill bit during drilling, which enhances the torque transfer.

For enhancing the stability of the drill head in the drill head holder the coupling means are preferably designed double, diametrically with respect to each other.

In a first further development thereof the first and second coupling means comprise a slot and a pin that is slidable therein, wherein the slot comprises an introduction section having an axial directional component and a confining section that is oriented substantially according to a line situated in a radial plane. The pin may for instance have a round cross-section. Alternatively the pin may have a rectangular cross-section, preferably with the short sides oriented axially.

The confining section may have a blind end section that is oriented according to a line that is at an angle to the radial plane, which angle deviates from zero degrees and is smaller than 10 degrees, preferably smaller than 5 degrees, wherein the end section in a direction towards its end has a proximally oriented directional component. In that way when placing the drill head it is urged closer in axial direction to the drill head holder and a better sealing is obtained there.

In a simple embodiment the slot is arranged in the drill head holder and the pin projects from the drill head. In that case the drill bit preferably comprises a proximally oriented support surface, wherein the drill head holder has a distally oriented end surface for engagement by the support surface of the drill bit, wherein the distance considered in axial direction between the support surface and the pin is smaller than or equal to the distance in axial direction between the edge situated at the distal side of the end of the slot and the end surface. In that way a clamping action is achieved as a result of which the coupling gains reliability. It is advantageous then when the said stop is provided on a shoulder, which in distal direction projects from the end surface of the drill head holder.

In a second further embodiment of the drill head assembly the first and second coupling means comprise a slot and a hole in the drill bit, which slot is bounded in distal direction by a lip and which hole is intended for fitting accommodation of the lip. Said stop can then be formed by the end of the slot itself. This embodiment is particularly advantageous in case of said double design of the coupling means, as more material of the wall of the drill head holder is available behind the stop, which is thus able to absorb higher forces.

According to a further aspect the invention provides a drill head provided with a coupling member for coupling to a drill tube, whether or not through the intermediary of a drill head holder, and a bit attached thereto, which bit itself has been provided with passages for a liquid, particularly a bentonite mixture and/or grout mixture. The bit may have a bit edge, wherein the liquid passages considered in drill rotation direction are situated immediately behind the bit edge. In that way the liquid is discharged in the front end of the drill head, as close as possible to the cut. This may be advantageous in the circulation of liquid for the stability and discharge of soil material, as well as for supplying liquid for the displacement or soaking of soil material.

Preferably the bit is plate-shaped having bit edges extending obliquely rearward from a tip. In that case the bit can be composed of two bit plates attached to each other, which plates in a direction transverse to the drill axis are offset and each define a bit edge that are almost diametrically situated with respect to each other. The passages can then be provided between both bit plates. Both bit plates offer each other support in rotation direction.

According to a further aspect the invention provides a drill head provided with a coupling member for coupling to a drill tube, whether or not through the intermediary of a drill head holder, and a plate-shaped bit attached thereto in side view having a triangular or pentagonal shape, wherein the bit in side view is substantially symmetrical and defines a tip, wherein two sides extend obliquely rearward from the tip and are provided with bit edges. In said oblique sides directly near the bit edges, the bit can be provided with passages for a liquid, particularly a bentonite mixture and/or grout mixture.

According to a further aspect the invention provides a device for moving a tubular element provided with a front end in a direction of its axis with the front end in the lead, comprising a frame having a pressure device with a number of pressure rollers that clampingly engage onto the outer side of the tubular element, means for in axis direction reciprocally moving the pressure device along the frame, wherein the pressure rollers are only rotatable in a direction in which the engagement surfaces of the pressure rollers move towards each other and towards the front end. With such a device the tubular element, such as a geothermal heat exchanger, can be inserted into a borehole in a quick and reliable manner. Such an introduction device is particularly usable in a method according to the invention.

The device may furthermore comprise a guiding device that is stationary on the frame with respect to the pressure device and is provided with guide rollers that are only rotatable in a direction in which the engagement surfaces of the guide rollers move towards each other and towards the front end.

For transfer of forces the frame may be provided with means for attachment to an introduction end of a drill tube.

According to a further aspect the invention provides a device for guiding a tubular element during its introduction into a tube, comprising means for attachment of the guiding device to the introduction end of the tube and guide rollers that are only rotatable in a direction in which the engagement surfaces of the guide rollers move towards each other and towards the leading end of the tubular element.

According to a further aspect the invention provides an anchor for anchoring an elongated element, such as a geothermal heat exchanger, in a borehole made in a soil, comprising an anchor rod and a holder for it, which holder is provided with means for attachment to the distal end of the elongated element, wherein the anchor rod in the vicinity of its centre is hinged to the holder and is rotatable between an introduction position substantially parallel to a distal end section of the elongated element and an anchoring position substantially perpendicular thereto. Preferably the holder is provided with an accommodation space for accommodation of the section of the anchor rod situated at one side of the hinge, so that in the introduction position the profile of the anchor can be as small as possible, as a result of which the introduction of the elongated element in a borehole and the like, is not impeded at least not to an undesirable degree. The holder may thus for instance comprise two strips that are able to accommodate an arm of the anchor rod in between them. The anchor may furthermore have a weight that is such that the elongated element is kept taut during the introduction into the borehole and the like. The anchor can be attached to an end cap of a geothermal heat exchanger having passages that are concentric with respect to each other for heat exchanging fluid flowing downward and upward again, respectively, wherein the end cap forms a turning means for said fluid.

According to a further aspect the invention provides a tube assembly, particularly intended to be used as geothermal heat exchanger, comprising an inner tube having an axis, forming a first passage for a flowing heat exchanger fluid, particularly liquid, particularly water, and an outer tube concentrically positioned around the inner tube while forming and annular space, which forms a second passage for the flowing heat exchanger fluid, wherein the inner tube is entirely made of thermally insulating material and provided with one or more ribs that abut the inner surface of the outer tube and are made of thermally insulating material and the outer tube is made of thermally conductive material. In that way the thermal transfer between ambient and the fluid in the first passage is counteracted to a large extent.

In a simple embodiment the ribs extend substantially continuously, considered in the direction of the tube assembly.

The ribs keep the inner tube centred within the outer tube and keep the inner tube and outer tube thermally insulated from each other. They divide the second passage into parallel channels.

In a first embodiment thereof the ribs extend parallel to the axis. Preferably there are more than two ribs which, preferably, considered in cross-section, are distributed regularly over the circumference.

In another embodiment thereof the ribs extend according to a helical line. In that case there can be two ribs. The pitch of the ribs then preferably is 360 degrees per at least approximately 1 m, preferably 360 degrees per more than approximately 1.5 m, for instance 360 degrees per 1.85 m. The base helix angle can be less than 20 degrees, preferably less than 10 degrees, for instance approximately 5 degrees or less.

With such a large pitch the hydraulic resistance can be kept limited, as a result of which the power required for the circulation of the exchanger liquid can be saved on.

The thermally insulating material of the inner tube and the ribs preferably is a synthetic foamed material with closed cells, particularly polyethene, more particularly an HDPE.

Preferably the ribs are integrally formed with the inner tube, particularly by extrusion.

The ratio between the flow-through surface inside the inner tube and the flow-through surface of the annular space may be in the range of approximately 1:1.5 to 1:4. Thus the flow-through surface in the annular space is larger than that of the inner tube, wherein the dimensions of the outer tube can remain within acceptable bounds. It is desirable that the borehole to be made is as small as possible (among others in view of saving on grout and limiting the damaging/influencing of the soil), however with sufficient effectiveness for the geothermal heat exchanger.

The ribs, considered in cross-section of the inner tube, may have a starting width (the shortest distance between both points where the flanks or sides of the ribs merge into the outer surface of the inner tube) that is larger than the protruding distance of the ribs (the distance measured in radial direction between a line connecting said points with each other and the radial outer tip or surface of the ribs).

In one embodiment the ribs, considered in cross-section, have flanks converging in radial outward direction. Preferably they have a substantially trapezoidal cross-section.

The outer tube can be made of a heat-conducting solid synthetic material, for instance solid HDPE.

At the distal end the tube assembly can be provided with an end cap which forms a turning means for the fluid.

The tube assembly can be supplied on a roll.

According to a further aspect the invention provides a tube assembly, particularly intended to be used as geothermal heat exchanger, comprising an inner tube bounding a first passage for a flowing heat exchanger fluid, particularly liquid, particularly water, and an outer tube concentrically positioned around the inner tube while forming an annular space, which forms a second passage for the flowing heat exchanger fluid, the ratio between the flow-through surface inside the inner tube and the flow-through surface of the annular space being in the range of approximately 1:1.5 to 1:4.

According to a further aspect the invention provides a tube assembly, particularly intended to be used as geothermal heat exchanger, comprising an inner tube bounding a first passage for a flowing heat exchanger fluid, particularly liquid, particularly water, and an outer tube concentrically positioned around the inner tube while forming an annular space, which forms a second passage for the flowing heat exchanger fluid, wherein the inner tube is provided with one or more ribs abutting the inner surface of the outer tube, wherein the ribs, considered in cross-section of the inner tube, have a starting width (the shortest distance between both points where the flanks or sides of the ribs merge into the outer surface of the inner tube) that is larger than the protruding distance of the ribs (the distance measured in radial direction between a line connecting said points with each other and the radial outer tip or surface of the ribs).

According to a further aspect the invention provides a splitter cap for connection to the end of a tube assembly, which tube assembly comprises an inner tube and an outer tube that are concentric with respect to each other and in the inner tube forms a first passage for a flowing heat exchanger fluid, particularly liquid, particularly water, and concentrically around it an annular space bounded by the outer tube, which annular space forms a second passage for the flowing heat exchanger fluid, wherein the cap is provided with a main passage surrounded by a casing of the cap which main passage splits in a third and a fourth passage, wherein the third passage is in line with the main passage, wherein the main passage has an inner diameter suitable for accommodation of the inner tube and the inner tube is secured therein by means of a sleeve extending in the third passage which sleeve has a passage that connects to the first passage and at its outer side is fluid-sealed against the surface of the third passage, wherein the fourth passage is in fluid connection with the space in the main passage between the inner tube and casing and the second passage. In that way the concentric arrangement of the passages is transferred to an arrangement that is fully adjacently positioned, for connection to the separated supply and discharge lines of a geothermal heat exchanger arrangement.

The third passage may have such a diameter that also the end of the outer tube can be snugly accommodated therein.

The sleeve may be threaded at one end so that it can be screwed into the inner tube. At the other end the sleeve can be provided with a stop for against the opening edge of the third passage, so that the inner tube can be pulled into the main passage by rotation of the sleeve.

The invention further provides a splitter cap according to the invention that is attached to the end of a tube assembly having said concentric first and second passages.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### BRIEF DESCRIPTION OF THE DRAWINGS

The invention will be elucidated on the basis of a number of exemplary embodiments shown in the attached drawings, in which:

FIG. 1 shows a schematic view of an arrangement including a greenhouse and a first exemplary embodiment of a tube assembly according to the invention.

FIG. 1A shows a schematic view of a distribution box that can be used in the arrangement of FIG. 1.

FIG. 2 shows a schematic view of an arrangement including a greenhouse and a second exemplary embodiment of a tube assembly according to the invention.

FIGS. 3A and 3B show a longitudinal section of the lower end of the tube assembly of FIG. 1 and a cross-section according to the plane 111B, respectively.

FIGS. 4A and 4B show a longitudinal section of the lower end of a third exemplary embodiment of a tube assembly according to the invention and a cross-section according to the plane IVB, respectively.

FIGS. 5A and 5B show a longitudinal section of the lower end of a fourth exemplary embodiment of a tube assembly according to the invention and a cross-section according to the plane VB, respectively.

FIG. 6 shows an example of an arrangement for making another exemplary embodiment of a tube assembly according to the invention.

FIGS. 7A and 7B show a side view of an insulation casing with rib for a tube assembly manufactured with the arrangement of FIG. 6 and such a tube assembly, in cross-section, respectively.

FIGS. 8A-H show a few consecutive steps in carrying out an example of a method according to the invention.

FIGS. 9A-E show a first embodiment of a drill head according to the invention, in a side view, in a cross-section according to arrow IIB, in a rear view according to arrow IIC, in a front view according to line IID and detail IIE, respectively.

FIGS. 10A-C show an assembly of drill head holder and drill head according to FIGS. 9A-E, the drill head, the drill head holder for it and the assembly, respectively.

FIGS. 11A-C show a second embodiment of an assembly of drill head holder and drill head according to the invention, the drill head, the drill head holder for it and the assembly, respectively.

FIGS. 12A-E show a third embodiment of an assembly of drill head holder and drill head according to the invention, the drill head in side view, in longitudinal section and in bottom view, respectively, and the assembly in side view and the assembly in perspective during assembling, respectively.

FIGS. 13A and 13B show a side view and a cross-section of a plug assembly for use in a method according to the invention.

FIGS. 14A and 14B show a side view of an inner tube for a tube assembly for a geothermal heat exchanger according to the invention and a cross-section of such a tube assembly, respectively.

FIGS. 14C and 14D show a side view of an alternative inner tube for a tube assembly for a geothermal heat exchanger according to the invention and a cross-section of such a tube assembly, respectively.

FIGS. 15A-C show a picture of the start of introducing a tube assembly according to the invention in a drill tube into the soil and a detail of the distal end or introduction end of the tube assembly, as well as said detail after removing the drill tube, respectively.

FIGS. 16A-E show a number of consecutive steps in realising the entrance and exit connections at the proximal end of the tube assembly and a cross-section of said connection.

FIG. 17 shows a schematic view of an arrangement for carrying out a method according to the invention.

FIGS. 18A and 18B show guiding and or introduction devices according to the invention, in oblique side view and in end view.

### DETAILED DESCRIPTION

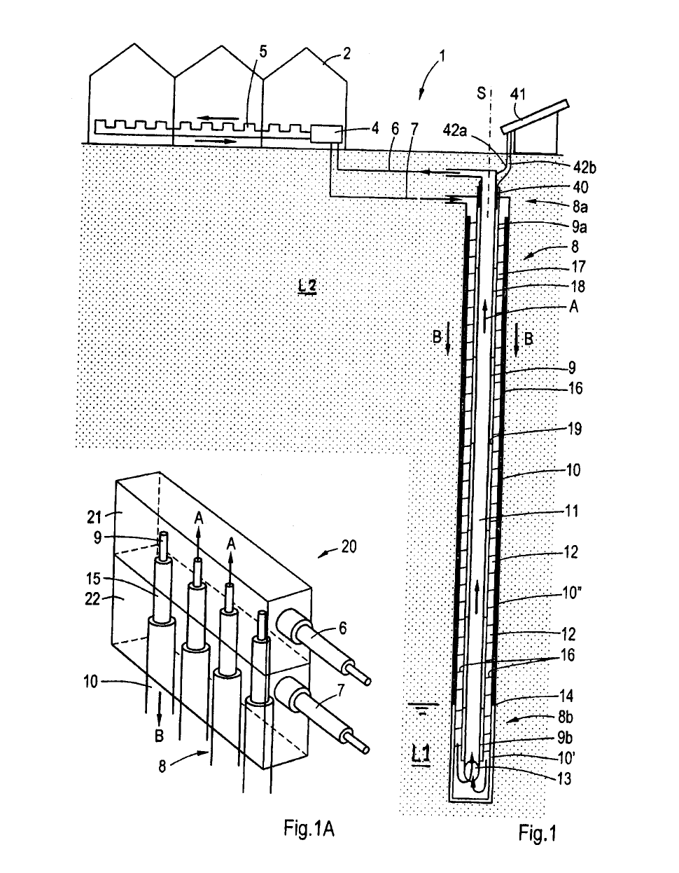

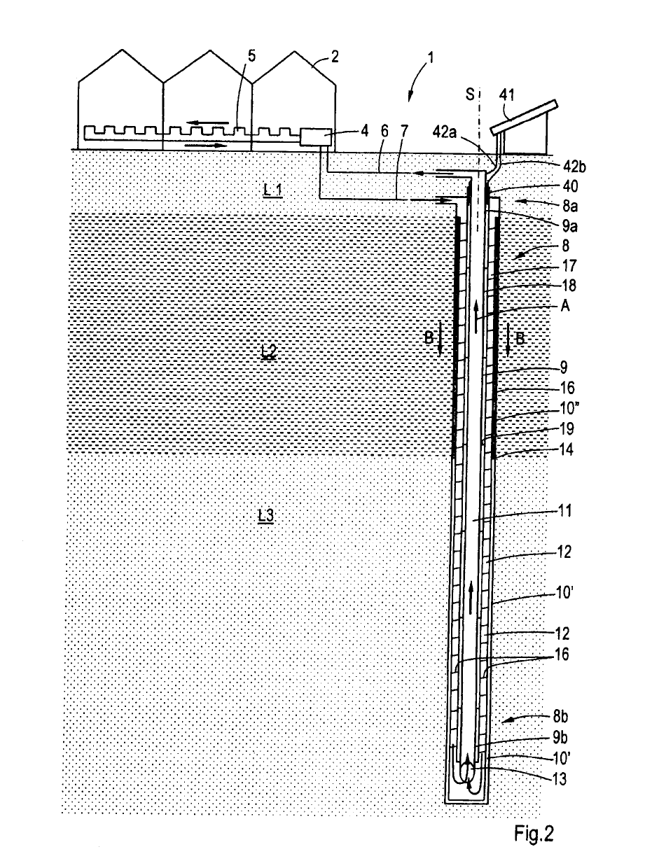

The arrangement 1 of FIG. 1 comprises a building and a series of heat exchangers 3, only one of which is shown, accommodated in a bottom. By means of a discharge line 6 and a supply line 7 for a fluid, such as water, the heat exchanger 3 is connected to a heat pump 4, in which thermal exchange takes place with an annular line 5 running through the building for cooling or heating it. The heat exchanger 3 comprises a tube assembly 8.

The tube assembly 8 comprises a first tube 9, comprising an inner tube, and concentrically situated around it a second or outer tube 10, according to common axis S. The tube 9 forms a channel 11 for fluid (direction A) to line 6. An annular space 12 is formed between the first tube 9 and the second tube 10. The fluid flowing therethrough (main direction B) coming from the line 7 and propelled therein by the pump 4 contacts the wall of the second tube 10 and via said wall is in thermal transfer contact with the ground, all this in accordance with the examples to be discussed below.

In the lower part 8b of the tube assembly 8 the second tube 10 comprises a steel blind end part 10′, in which the transition of the fluid flow from the annular space 12 to the inside 11 of the first tube 9 takes place. For enhancing the circulation, the lower end 9b of the first tube 9 is provided with a slanted opening 13, in a manner comparable with a hypodermic syringe or a flower stem cut off at a slant. Via a connection 14 that is leakage-proof (for instance by means of edges inserted into each other that are glued together) the end part 10′ connects to tube part 10″, that is made of synthetic material, for instance HDPE. The tube part 10″ is built up from a number of longitudinal sections/lengths, that are also attached to each other in a leakage-proof manner. The first tube 9 can be built up in parts accordingly, wherein the parts of the second tube 10 each time form a composite unity with the related parts of first tube 9. Such units can then be connected to each other into the tube assembly 8.

At the upper end 9a the first tube 9 is surrounded by a sleeve 40 of polymer foil filled with conducting material such as carbon fibres. The sleeve 40 is interrupted to form two edges where two electrodes have been arranged which via guides 42a,b are connected to both terminals of a PV panel 41. The power generated by the PV panel 41 can thus be utilised for heating the upper end of the first tube 9 and thus the liquid flowing therefrom to line 6. This provision can be made use of when the liquid has to be heated in the ground.

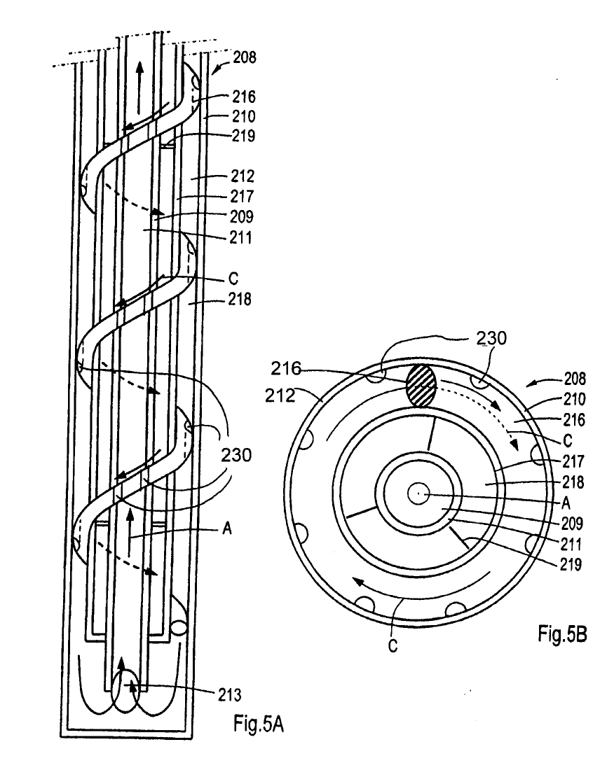

The annular space 12 is provided with two helical strips 16a,b (also see FIGS. 3A and 3B), having an axis coinciding with those of the tubes 9, 10, in order to give the fluid flow a tangential directional component, so that the resulting flow direction becomes C and the flow path much longer than the length of the annular space 12. In that way a turbulent flow is achieved as well, as a result of which the thermal transfer between the wall of the second tube 10 and the liquid is enhanced. At their edge near the inner surface of the tube 10 the helical strips 16 are provided with axial through-holes 30, for improving the development of a turbulent flow. The strips 16 may also be provided with profilings for increasing the turbulence. The helical strips 16a,b have a mutually equal and constant pitch.

The strips 16 extend from the outer surface of the first tube 9 up to the inner surface of the outer tube 10 and ensure a coaxially retaining of both tubes, as well as increasing the bending stiffness of the tube assembly. This is advantageous for handling the tube assembly, particularly when supplying a tube assembly in the ground from a reel, in order to prevent buckling in the then curved outer tube. When the outer tube has to extend to great depths the strips are able to support the outer tube against a high soil pressure.

The strips 16 may be fixed, for instance by gluing, with the first tube 9 and/or outer tube 10, or with the aforementioned parts thereof. In case of synthetic tubes they can be integrally formed therewith of the same material.

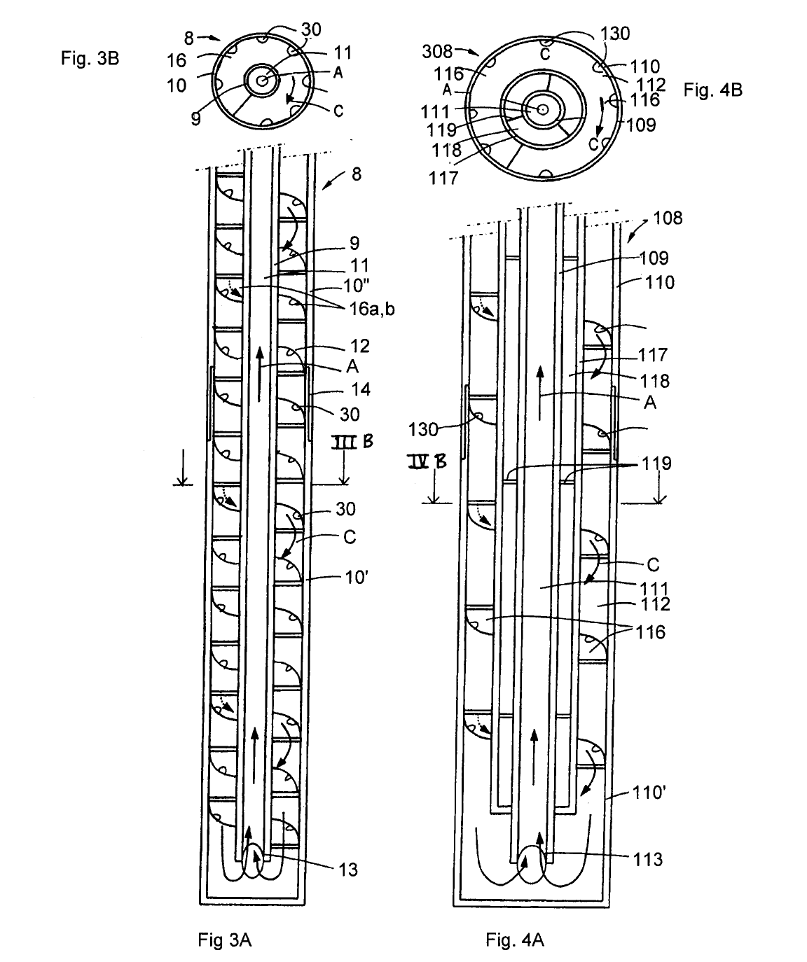

The strips are depicted in a highly schematic manner only in FIG. 1 (and FIG. 2), wherein the shown incline is only for indicating that there is question of a helical shape: in FIGS. 1, 2, 3A and 3B the strips 16a,b, 16 are in fact flat, with radial intersecting lines with an axial longitudinal plane of cross-section. Preferably, however, in that cross-section they are slanting towards the outer tube 10, preferably on either side, having an opposite sign with respect to a radial plane.

As can be seen in FIG. 3B the cross-section of the annular space 12 is larger than the cross-section of the passage 11. In that way the rate of flow in the annular space 12 can be low, as a result of which the length of stay is longer in the annular space 12 and the thermal transfer with the ground is improved.

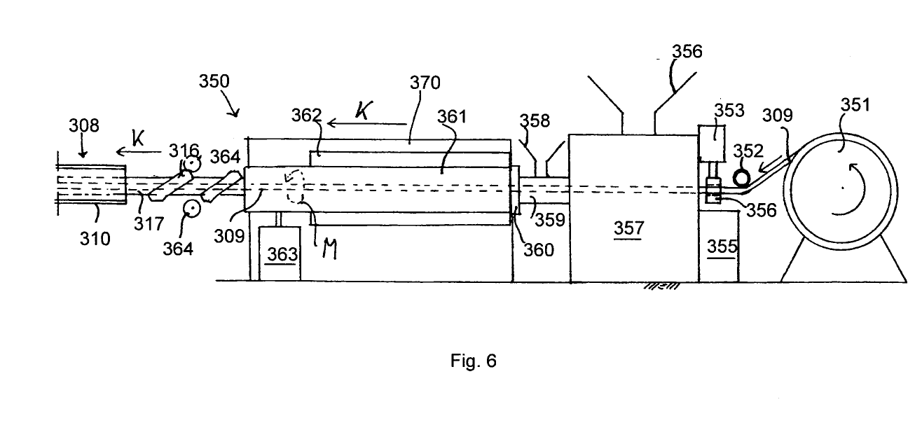

In the alternative embodiment of the tube assembly shown in FIGS. 4A and 4B parts comparable to those of FIGS. 3A and 3B have been provided with the same reference number, increased by 100. The pitch of the strips 116 here is shown slightly enlarged, but in actual practice it will be comparable to those of strips 16a,b. The first tube apart from an inner tube 109 also comprises an intermediate tube 117, for by means of intermediate spacer means in the form of spacer partitions 119 coaxially with the inner tube 109, forming an intermediate annular space 118 filled with air. The spacer partitions have been provided at the top and at the bottom in the tube assembly, and furthermore can be placed at relatively large intermediate distances, wherein as much as possible a concentric position of the inner tube and the intermediate tube is preferred however. The intermediate tube 117 can be made of synthetic material, such as HDPE, and the distribution in axial direction of the tubes 109 and 110 follow. In addition there may also be question of length units that can be connected to each other. The air-filled intermediate annular space 118 enhances the thermal insulation between the annular space 112 and the passage 111, as a result of which the mutual thermal influencing of the opposite liquid flows is minimised. In case of a desired heating of the liquid, the liquid coming out of the upper end of the inner tube 109 can be additionally heated by hotter air rising in the intermediate annular space 118, which air may possibly have been heated by the transfer through the wall of the inner tube 109, so that loss is compensated to some degree.

In FIG. 1 the tube assembly extends through a bottom built up wholly from sand layers L1,L2, for instance to a depth of 15 meters. The metal (or other material that conducts heat well) end part 10′ extends in water conducting sand layer L1. In order to improve thermal transfer and concentrate it more in the layer L1, the part 10″ is made of synthetic material having a much lower coefficient of heat conduction, such as PVC.

In FIG. 2 an arrangement 101 is shown comparable to the one of FIG. 1, in which similar parts have the same numbers. The soil structure is different, in which the water guiding sand layer L3 extends higher and is covered by a clay layer L2, covered by a top layer L1 of sand. In this case the metal pipe part 10′ extends higher, up to the bottom side of clay layer L2, through which synthetic parts 10″ extend. When the tube assembly extends through several spaced apart water guiding sand layers, the outer tube 10 in those individual sections can be made of properly conducting material, such as said metal/steel.

As shown in FIG. 1A several tube assemblies 8 can be connected to a distribution box 20, with a first distribution chamber 21 connected to line 6 and a second distribution chamber 22 connected to line 7. The ends of the first tubes 9 that extend through the chamber 22 are surrounded by heat insulation 15. The distribution box 20 can be buried in the bottom.

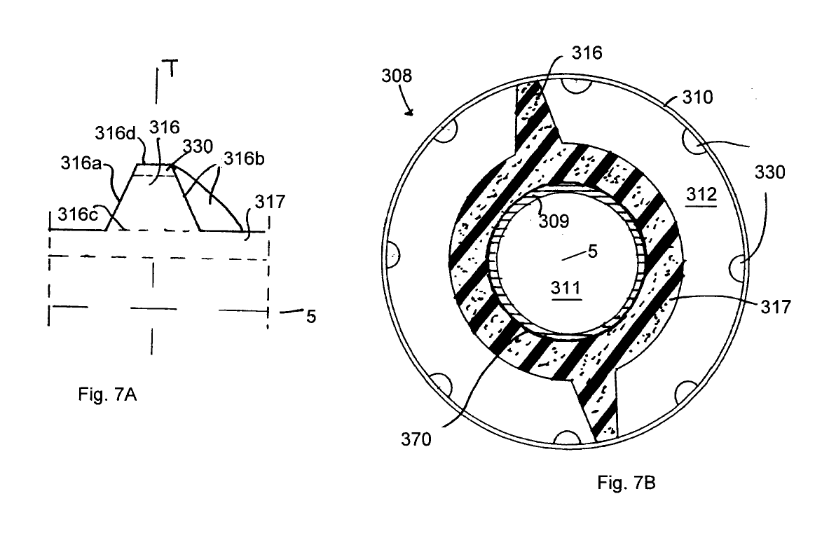

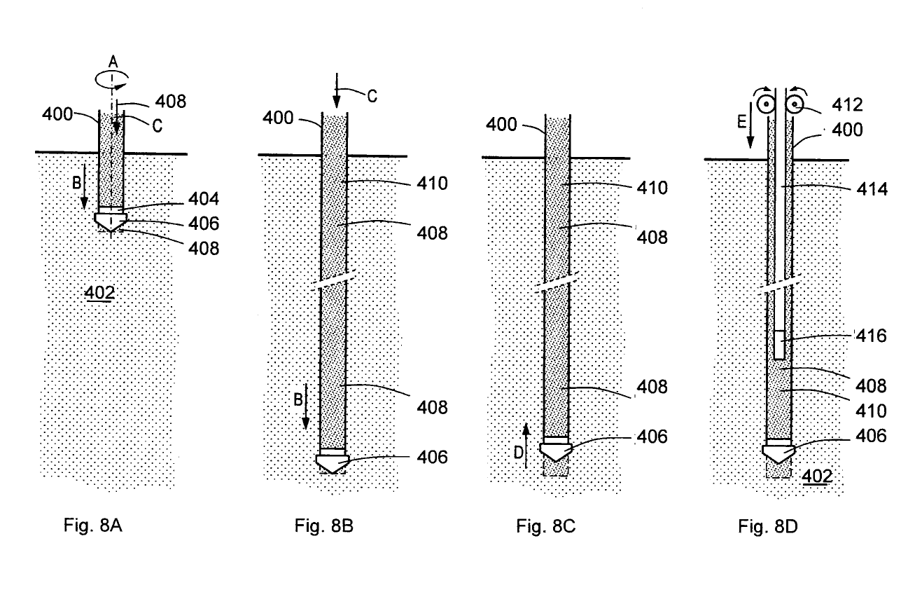

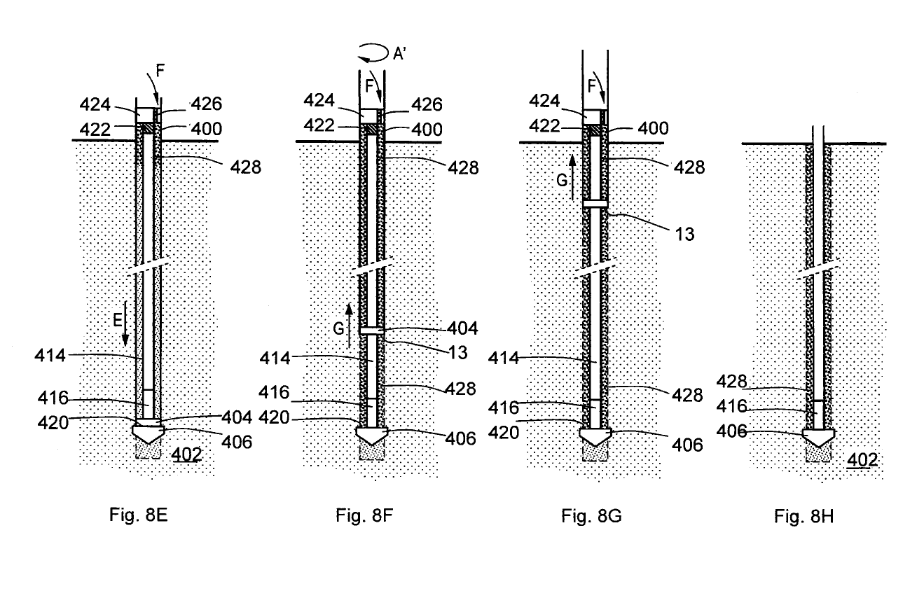

In FIGS. 5A and 5B a part of a tube assembly 208 is shown, which largely corresponds with tube assembly 108 of FIGS. 4A,B. The difference being that the helical strips 116 have been replaced by a thick, helical cord or wire 216, that may have been extruded along and which with the outer surface of the intermediate tube 217 and the inner surface of the outer tube 210 defines a helical flow channel (direction C) which in axial direction S is relatively broad (with respect to the intermediate distance second tube-intermediate tube). The cord or wire 216 may also have been made of a synthetic foamed material, in accordance with the ribs to be discussed in connection with the FIGS. 6 and 7A,B.

Near the wall of the outer tube 210 the helical element 216 is provided with holes 230, via which liquid can be exchanged between consecutive flow path sections, as a result of which the turbulence is increased. Profilings on the helical element 216 may also be made use of.

A comparable arrangement of helical cord can also be used in the embodiment of FIGS. 3A,B.

As the outer tube forms the direct connection between the annular space 12, etc. and the ground, thermal transfer is strongly enhanced and the turbulent and the extended contact time fluid-second tube wall can be profited from.

The first tube or tube defining the inner wall for the intermediate annular space may beforehand have been provided with flow directors and/or turbulence increasing means and as one unity have been inserted into an outer tube. Due to the smaller operational length/depth required, the length of the tube assembly can be limited to such an extent that assembly in the factory is possible (which ensures higher quality) and furthermore stretched transportation on a semi trailer to the project is possible, optionally with the tube assembly being completely assembled, that means including outer tube.

When the nature of the various soil layers has to be adjusted to, it may be opted for to build up the tube assembly from lengths of tube assembly that are joined together in the factory or in situ. As regards number and position of the directing means and turbulence means, the separate parts may be adjusted thereto, for instance for a quick and smooth transport through an HDPE tube part intended for a layer that absorbs heat with difficulty and for a slowed down, turbulent transport through a steel tube part intended for a water-containing sand layer.

With the exemplary embodiment of an arrangement 350 shown in FIG. 6, an advantageous embodiment of a tube assembly according to the invention can be made. The arrangement 350 comprises a reel 351 having a stock of inner tube 309 made earlier. Downstream thereof a tension roller 352 is placed, so that the tube 309 is guided taut through the further arrangement.

A stock 353 for anti-adhesive means dispenses said means to a ring 354, with which the anti-adhesive means is applied onto the outer surface of the inner tube 309.

A funnel 306 serves as supply for a synthetic granular material to a heating unit 357, where the granular material is formed into a viscous mass. Downstream thereof there is a supply 358 for a foaming agent that is mixed with said mass in a mixer 359. Downstream thereof an extruder 370 is positioned, which is provided with a rotating profiled extrusion head/die 361 having a cooler 362 surrounding it. The extrusion head 361 is elongated, for instance having a length of over 1 m, for instance approximately 2 m. The profile of the extrusion head 361 is such that an annular body is made, having a circular inner surface and a largely circular outer surface, however having two radial protrusions that are situated diametrically opposite. The extrusion head 361 is driven in rotation (M) by motor 363 and rotates at an upstream side in a bearing 360 (the downstream bearing is not shown, but will be comparable). A central control unit 355 is provided for controlling and mutually adjusting all operating parts that are shown and not shown.

Downstream of the extruder 370 a ring of milling wheels 364 is positioned. The number may for instance be eight, distributed regularly over the circumference.

When making a tube assembly as shown in FIG. 7B, an inner tube 309 of for instance HDPE 80 or 100 is taken from the reel and moved towards and through the extruder (K), using drive means that are not further shown, kept taut by the tensioning roller 352.

Near the ring 354 the anti-adhesive, such as silicone, is applied onto the outer surface of the inner tube 309. The inner tube 309 is transported to the extruder 370, past the heating unit 357.

At the location of the extruder 370 the mixture coming from the mixer 359 is pressed around the inner tube 309, wherein the extrusion head 361 rotates around the inner tube 309 that does not rotate. In that case a casing 317 of foamed material is laid around the inner tube 309, wherein due to continuous transport the radial protrusions form helical ribs 316. The mixture may for instance be foamed PE 80 with closed cells. The cell walls of the closed cells increase the strength and the closed cell volumes increase the insulating value. The surface of the foamed material of the casing and the rib are closed and made smooth in the extrusion process.

After the assembly of inner tube 309 including insulation casing 317 thus obtained exits the extruder 370 and the material has set sufficiently, an axially continuous recess 330 is milled in the ribs by means of milling wheels 364.

Subsequently the assembly of inner tube 309 and insulation casing 317 is inserted in a snugly fitting manner into a piece of outer tube 310 kept ready, for instance made of HDPE 125 or a steel.

When the outer tube 310 has accommodated sufficient length of inner tube 309 with insulation casing 317, the latter is cut through and a subsequent length of outer tube 310 is placed. The process may in that case take place almost continuously.

The result, tube assembly 308, can be seen in cross-section in FIG. 7B. By way of example the external diameter may be 59 mm, the internal diameter of the outer tube 310 56 mm, the external diameter of the ribs 316 56 mm, the external diameter of the casing 317 36 mm, the external diameter of the inner tube 309 25 mm and the internal diameter of the inner tube 309 20 mm.

The material of the ribs 316 can be slightly pressed in, as a result of which abutment against the outer tube 310 is ensured.

As shown in FIG. 7A the rib 316 may be trapezoidal in cross-section, having flanks 316a,b that converge towards each other and incline in an opposite manner with respect to a radial plane T perpendicular to the axis S. The outer side 316d of the trapezium is shorter than its notional inner side 316c.

When the lower end of the inner tube 309 is cut off at a slant for forming a large passage, such as in order to form said slanted opening 13, the casing 317 can first easily be cut through in situ and the lower part be removed as adhesion between the casing 310 and the inner tube 309 is prevented by the silicone.

It is noted that other ways of manufacturing are possible, such as by supplying the materials for rib and casing separately from each other, in case for instance different materials are opted for. A rotatable mandrel in the extruder can also be opted for.

The pitch of the helical ribs, or guides is selected such that a sufficiently long flow path is realised in the annular space and the pump used has sufficient capacity for the circulation of the fluid through the heat exchanger. The pitch of the ribs and the like can be smaller than the inner diameter of the outer tube, for instance approximately a half thereof, or even smaller, for instance approximately a quarter thereof, or even smaller. In the said dimensional example the pitch may for instance be 15 cm.

It is noted that in a heat exchanger arrangement in a soil the tube assembly according to the invention need not always be substantially vertically oriented. Other orientations are also possible, even a horizontal one.

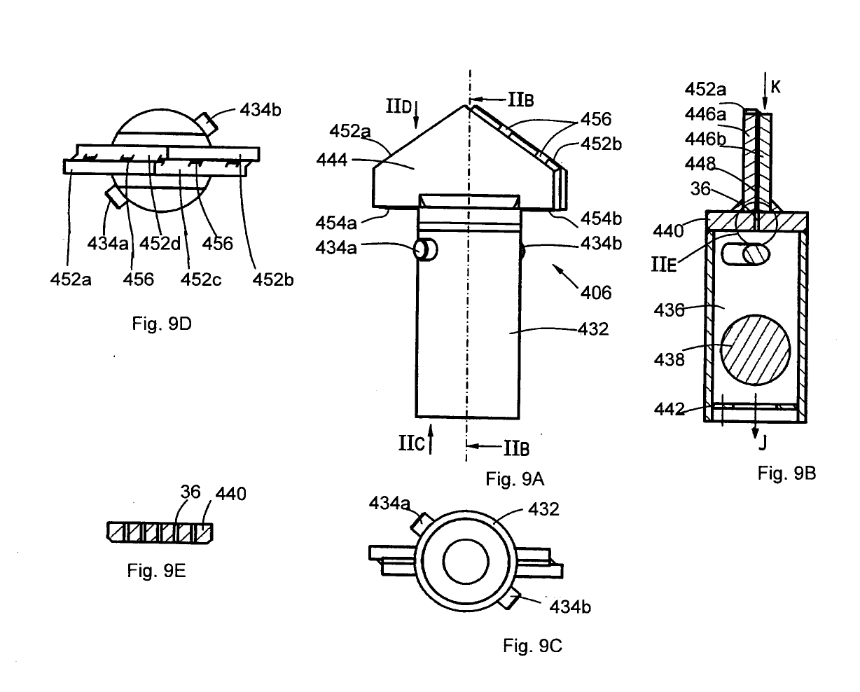

In FIGS. 8A-H a method according to the invention is shown in vertical use, but the method can also be carried out at angles deviating from the vertical.

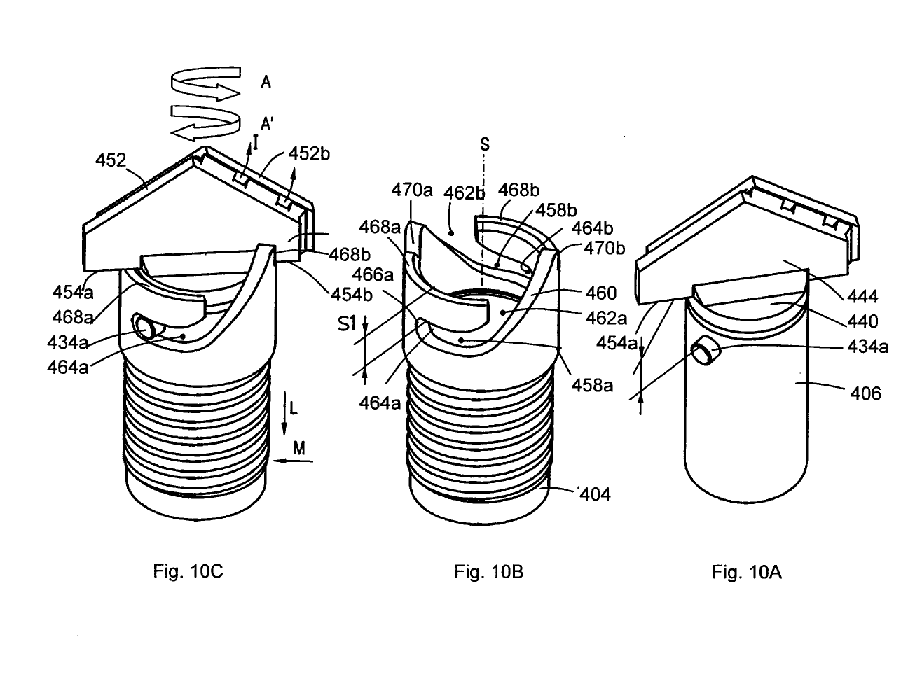

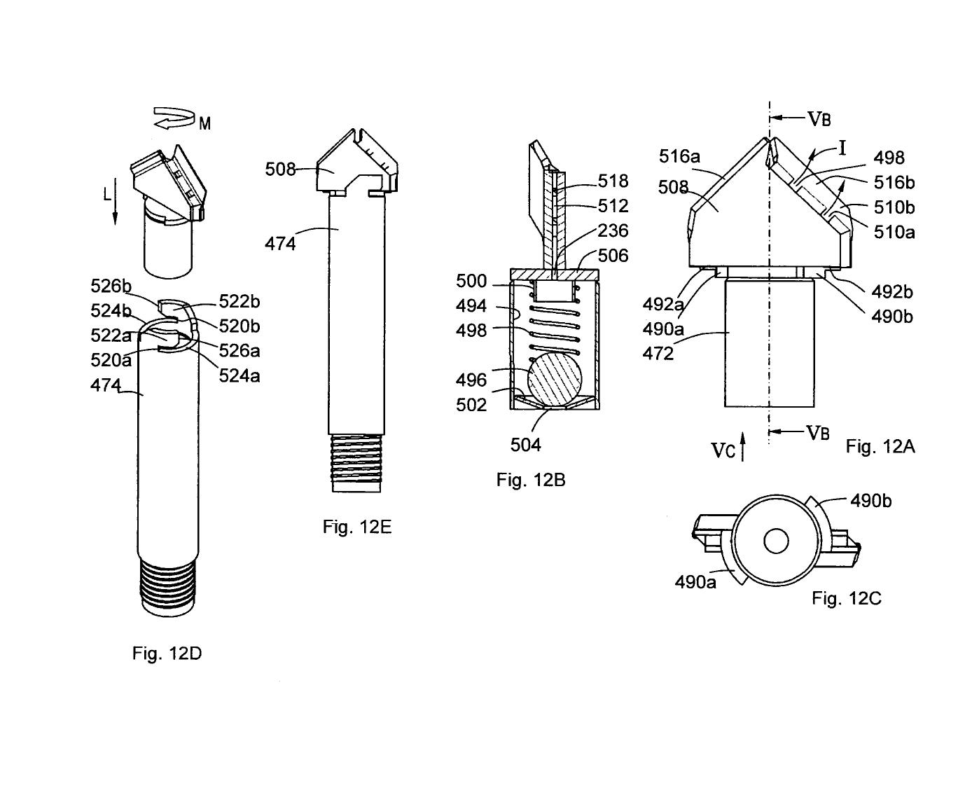

In FIG. 8A a drill tube 400 is drilled section by section into the soil 402 (direction B) using a rotary head that is not shown which rotates in the direction A and after placement of a next drill tube section is coupled to the upper edge thereof. At the lower end, distal end or leading end, the drill tube 400 is provided with a drill tube holder 404 and a drill head 406 that is detachably connected thereto, see the possible embodiments of FIGS. 9A-C and 10A-C as well as those of FIGS. 11A-C and 12A-E.

During drilling liquid 408 is supplied (direction C) in the inside 410 of the drill tube 400. Said liquid 408 exits from holes in the drill head 406 and by circulation, known per se, ensures discharge of the soil material from the borehole. The liquid 408 can also be used for soaking or forcing aside soil material.

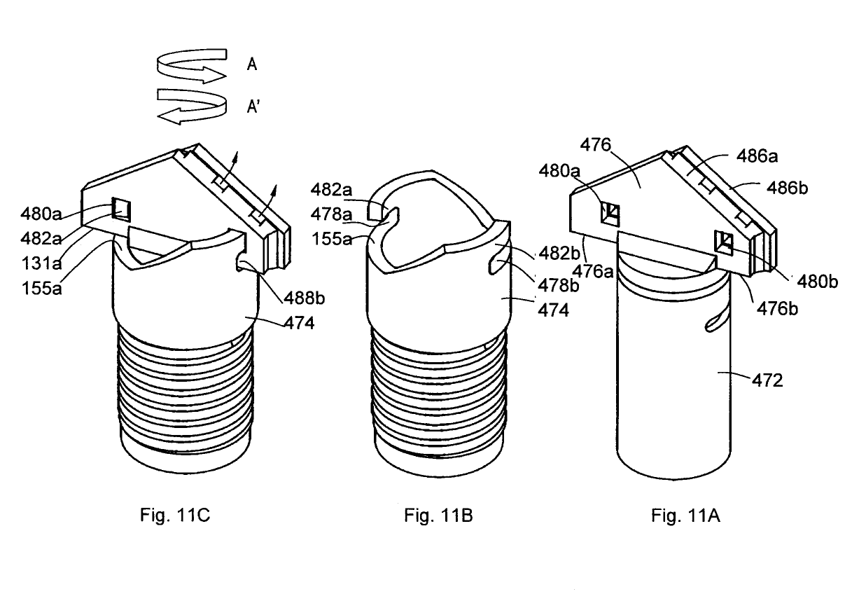

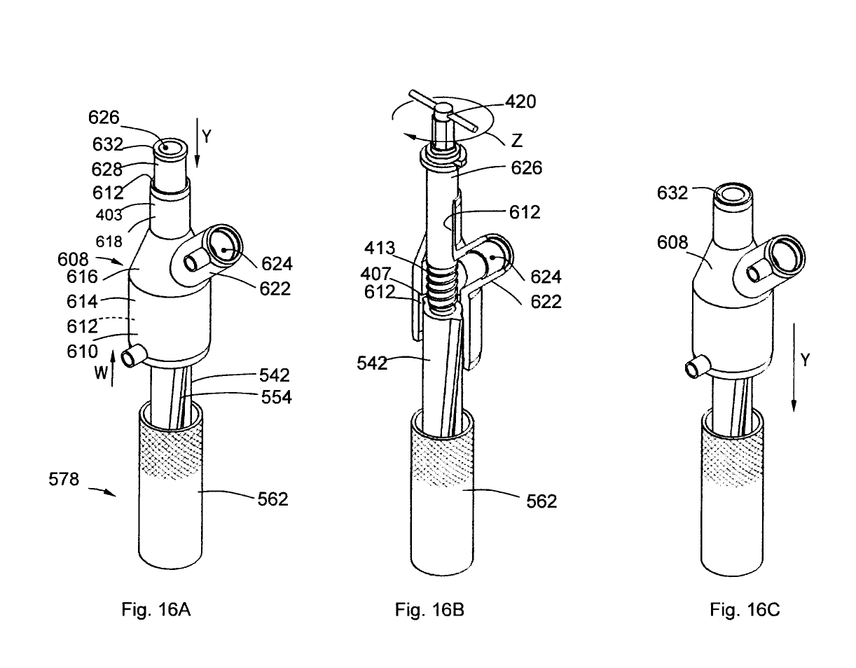

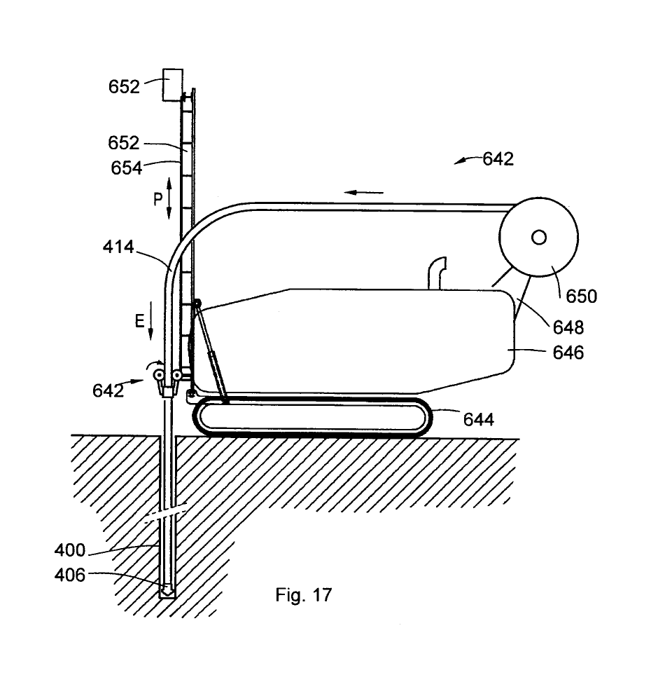

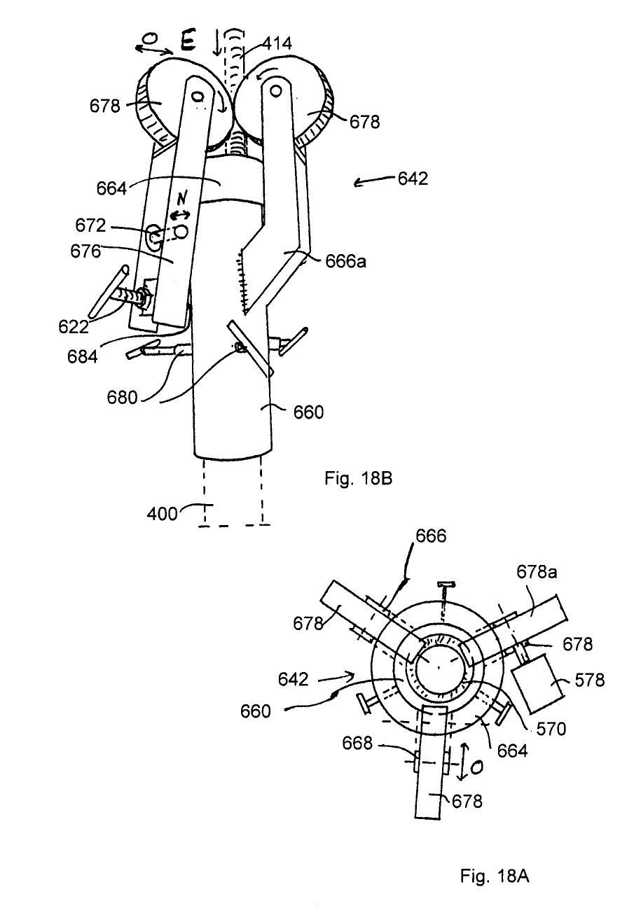

In FIG. 8B the desired deepest point (for instance 20-50 m) has been reached. The drill tube 400 is then slightly retracted (direction D, FIG. 8C), for instance 1 m, and subsequently, see FIG. 8D, by means of a drive 412 (see for instance the discussions of FIGS. 17, 18 or of FIG. 15A) an terrestrial heat probe or terrestrial heat exchanger 414 is inserted into the inside 410 of the drill tube 400 (direction E) filled with flushing liquid 408. The flushing liquid 408 offers little resistance against this. For the introduction process FIG. 10 can also be referred to.

When the lower end 418 of the heat exchanger 414 has arrived at the drill tip, and in addition also extends through the drill head holder, it may optionally be coupled to the drill head 406, at the location of 420 (FIG. 8E).

Alternatively, as shown in FIGS. 15A-C to be further discussed, an anchor can be used, in which case coupling to the drill tip is not required. Instead of an anchor or in addition thereto use can be made of weighting the heat exchanger 414, by an added weight attached at the bottom and/or by filling with water.

After that, also see FIG. 8E, the upper end of the heat exchanger 414 is sealed off in order to prevent that grout and the like enters into its passages. Prior thereto the heat exchanger 414 can be filled with water so that it acquirers a higher weight and is better able to set in the drill tube and after that in the borehole.

In a simple embodiment the upper end of the heat exchanger 414 is sealed off with a closed cap that can be removed later on.

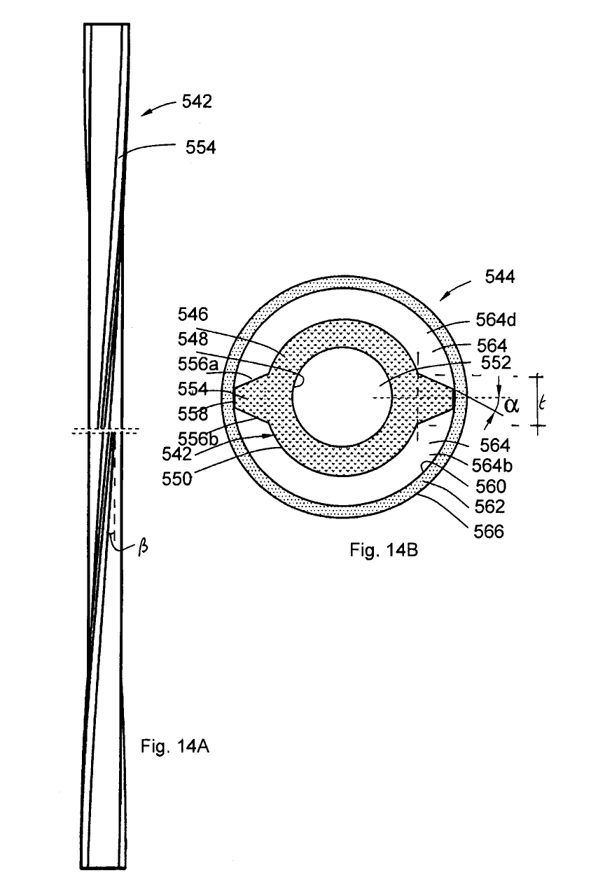

In another embodiment the heat exchanger 414 is sealed off at the top with a plug 422 and (after that or prior to that) a synthetic plug 424 is placed on top of it, which plug is provided with a slide sealing against the drill tube 400. The plug 424 is provided with a through-channel 426, though which grout 428 is inserted, under a pressure of 20-60 bar (direction F). Said grout 428 displaces the flushing liquid 408. The plugs 422 and 424 are shown more closely in FIGS. 13A and 13B, see sealings 430.

After the inside of the drill tube 400 has been filled with grout 428 the drill head holder 404 is uncoupled from the drill head 406, by rotating the drill tube 400 in direction A′ and lift it in direction G, FIG. 8F. When lifting the drill tube 400 the top drill tube section slides sealingly along the plug 424, whereas the grout 428 is kept at the high pressure via channel 426. As a result an undesired underpressure below the lower end of the drill tube 400 is prevented and the borehole wall remains filled with grout 428 and intact. The drill head 406 and the heat exchanger 414 remain in their place.

When a drill tube section can be detached from the rest of the drill tube 400 the connection of the grout source with the channel 426 is temporarily ended. The plug 424 will then also remain in place in case of a high pressure in the space below the plug 424. Also see FIGS. 8F and 8G.

When the entire drill tube 400 has been lifted the plug 422 is also removed and the heat exchanger 414 can be connected to the supply and discharge lines of the exchanger medium. The heat exchanger or heat probe 414 is enveloped by the heat conducting grout 428, see FIG. 8H.

The drill head 406 of the FIGS. 9A-E and 10A comprise a length of tube 432 which at the outside is provided with two diametrically extending pins 434a and 434b. The length of tube 432 forms a chamber 436, in which a floating valve or ball 438 is reciprocally movable, between the end wall 440 and a ball seating 442. On the end wall a bit 444 is welded comprising a pair of bit plates 446a,b that are welded to one another while leaving passages 448 free between them, which passages 448 are connected to the chamber 436 by passages 450 in the end wall 440. The bit plates 446a,b have an almost symmetrical pentagonal shape, like the shape of a little house, wherein of each bit plate one inclined edge forms a bit edge 452a,b. With their bottom side both plates extend radially in order to form axially rearwardly oriented support surfaces 454a,b. Because both plates are slightly offset with respect to one another the other inclined edge 452c,d is situated slightly lower than the adjacent bit edge, in other words in its shadow, considered in relation to the drill rotation direction A. At that location, between both inclined edges 452a,c and 452b,d holes 456 are provided, which continue the passages 448, so that liquid may exit in the direction I.

When the hydraulic pressure in front of the drill head 406 exceeds the pressure of the liquid in the supply, then the ball 438 is pressed against the seating 442 and further inflow of liquid (with soil material) in the direction K and J is prevented.

The drill head 406 can, as shown in FIGS. 10A-C, be joined with a drill head holder 404, which can be attached to the front end of a drill tube 400. The drill head holder 404 is provided with coupling or connection means for cooperation with the bit 444 and the pins 434a,b of the drill head 406. For that purpose the drill head holder 404 is provided with two slots 458a,b in the end edge 460, which slots each have a predominantly axially oriented insertion section 462a,b and a confining section 464a,b oriented in circumferential direction and ending in a stop edge 466a,b. The confining section can be at 90 degrees to the tube axis S, or at a small angle run rearward, direction stop edge. The end edge 460 furthermore comprises edges 468a,b that are situated in a plane that is at 90 degrees to the tube axis S. Shoulders 470a,b extend in axial direction from the edges 468a,b and form tangentially oriented stop surfaces.

When placing the drill head 406 in the holder 404 the pins 434a,b are brought in the slots 458a,b direction L, and the drill head 406 is rotated in direction M, in the confining sections 464a,b until the pins 434a,b nearly or fully abut the stop edges 466a,b in any case until the bit plates 446a,b abut the stop surfaces 470a,b. The axial distance S1 between the distal edge of the confining section 464a,b and the edges 468a,b corresponds with the axial distance S2 between the pin 434a,b and support surface 454a,b. The drill head 406 is then reliably attached on the holder 404, yet detachably, when the holder 404 is rotated in the opposite sense A′. When drilling, rotation direction A, the connection is self-reinforcing, wherein the bit 444 is supported by the shoulder 470a,b.

If the confining sections 464a,b take up the aforementioned small angle and S1 in the direction of M increases to S1>S2, a clamping action can be realised and the pin 434a,b will remain at a short distance from the stop surface 466a,b.

The alternative embodiment of the drill head 472 and drill head holder 474 of FIGS. 11A-C is characterised in that a part of the bit 476 itself is accommodated in the slots 478a,b. For that purpose the bit 476 is provided with holes 480a,b in which in a fitting and slidable manner a lip or finger 482a,b formed at the end edge 484 of the holder 474 can be accommodated. During drilling the bit plates 486a,b find support against stop surface 488a,b.

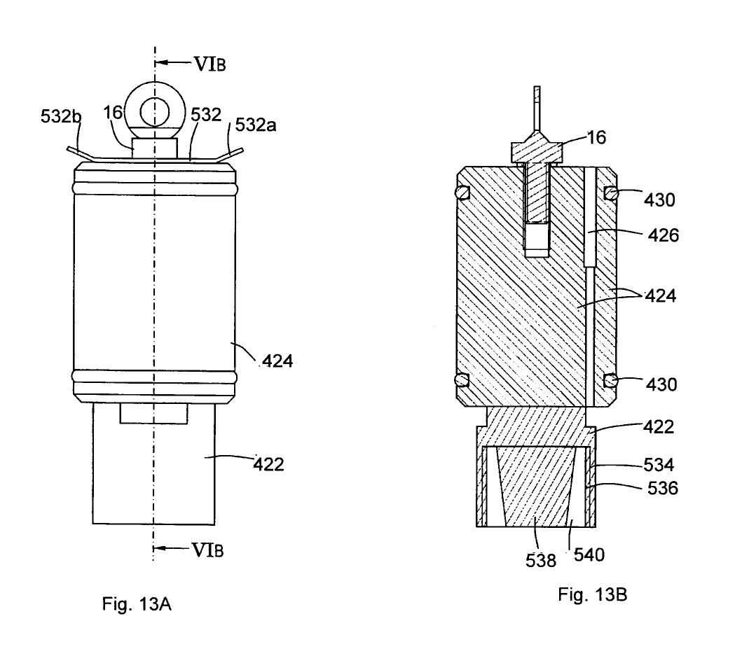

In the embodiment of FIGS. 12A-E, which at this moment is preferred, the pin 490a,b attached on the length of tube is flat or rectangular and furthermore it is welded against the support surface 492a,b. The length of tube forms a chamber 494 in which a one-way valve is housed, which comprises a valve or ball 496 which by means of compression spring 498 held by a fixed bush 500 is biased towards seating 502 in order to close a passage 504. On the end wall 506 a bit 508 is welded, comprising a pair of bit plates 510a,b that are welded to one another while leaving passages 512 free between them, which passages 512 are connected to the chamber 494 by passages 514 in the end wall 506. The bit plates 510a,b have an almost symmetrical pentagonal shape, wherein of each bit plate one inclined edge forms a bit edge 516a,b. With their bottom side both plates extend radially about axially rearwardly oriented support surfaces 518a,b. Because both plates are slightly offset with respect to one another the other inclined edge 516c,d is situated slightly lower than the added bit edge, in other words, in its shadow, considered in relation to the drill rotation direction A. At that location, between both inclined edges 516a,c and 516b,d holes 519 are provided, which continue the passages 512, so that liquid may exit in the direction I.

The ball 496 is urged from the seating 502, counter the spring force, when the pressure of the liquid supplied through the drill tube exceeds the hydraulic pressure in front of the drill head. If that is not the case the spring 498, which presses the ball 496 against the seating 502, prevents further inflow of liquid (including soil material) in the direction J and K.

The holder 474 is provided with slots 520a,b that are bounded in forward or distal axial direction by lips 522a,b and in rearward axial direction are bounded by edges 524a,b. The lips 522a,b end in stop surfaces 526a,b. When assembling (FIG. 12D) the pins 490a,b are brought in front of the insertion sections 528a,b and the drill head 472 is moved in direction L, until the pins 490a,b abut the edges 524a,b. Subsequently the drill head 472 is rotated in the direction M, until the bit 476 abuts the stop surfaces 526a,b, see FIG. 12E. The lip 522a,b can in this case have sufficient width in axial direction for strength. The pins 490a,b engage onto the edges of the slots 520a,b over a considerable length.

With part 530 the composite plug 422/424 of FIGS. 13A,B has an engagement point at the top for a tool to move the plug 424 within the tube, should this be necessary. In order to prevent that the plug 424 moves upward with respect to the tube in case of a pressure difference over the plug 424, the plug 424 is provided with a strip 532 having turned ends 532a,b that are able to engage in the tube wall for fixation against upward movement.

In FIGS. 13A,B the plugs 422 and 424 form an assembly, that can be handled as one unity. The plug 422 comprises a casing 534 that is provided with an internal thread 536, and with a core 538 provided with pilot surfaces defines a ring slot 540 for accommodation of the wall of a heat exchanger 414.

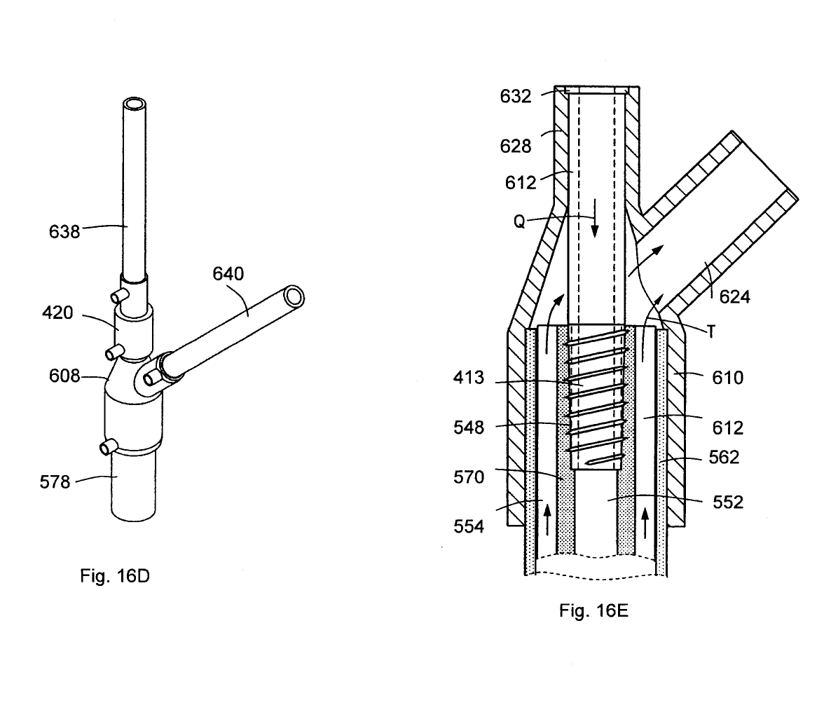

The heat exchanger 414 can substantially be built up from a tube assembly having an inner tube and an outer tube concentrically surrounding it, wherein a liquid that is to absorb heat from a soil, flows downward through the inner tube and flows upward through an annular space formed between the inner tube and outer tube. In case of discharge of heat to the soil the circulation can be the other way round. At the lower end or distal end an end cap is provided, where the liquid, such as water, can turn and is able to change from the (first) passage in the inner tube to the (second) passage formed by the annular space, or the other way round. At the upper end for both passages a connection is provided to supply and discharge lines, for instance to a heat pump. Advantageous exemplary embodiments of end cap and top connection (entrance/exit cap) are discussed below on the basis of FIGS. 15 and 16.

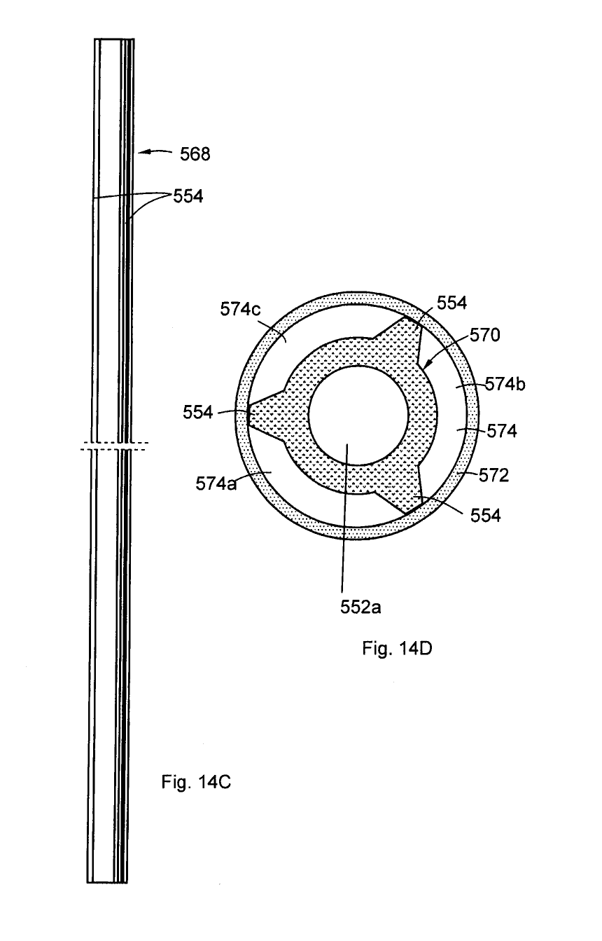

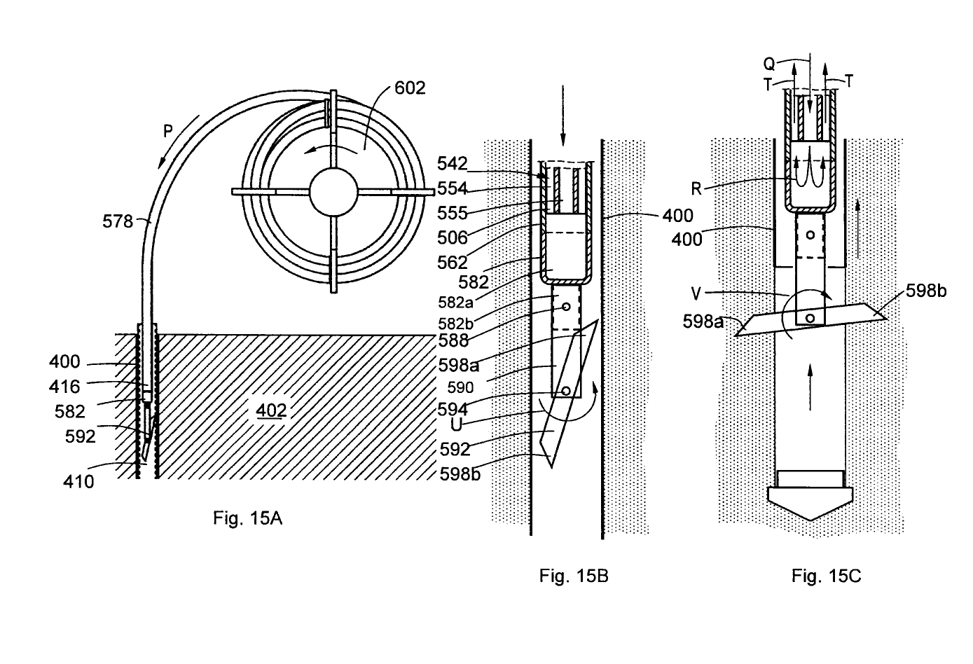

In FIG. 14A a side view of a first embodiment of an inner tube 542 for a tube assembly 544 is shown. The inner tube 542 is made by extrusion from foamed HDPE with closed cells. The content of open space in there can be approximately 40%. The inner tube 542, also see FIG. 14B, has a wall 546 with an inner surface 548 and an outer surface 550, wherein the inner surface 548 defines a first passage 552. At locations that are diametrically opposite each other ribs 554 of the same material are integrally formed therewith. The ribs 554 have flanks 556a,b that converge in radial outward direction. The ribs 554 have end surfaces 558 that are intended to abut the inner surface 560 of the outer tube 562. The outer tube 562 is made from solid HDPE and is thermally conductive. Between the inner surface 560 of the outer tube 562 and the outer surface 550 of the inner tube 542 a second passage 564 is defined, which is divided by the ribs 554 into two partial passages of equal cross-section. As a result of the insulating properties of inner tube 542 and the ribs 554 provided thereon, the liquid flows in the first passage 552 and the second passage 564 are thermally insulated from each other.

By way of example in one embodiment for the outer tube 562 an outer diameter of 63 mm (of outer surface 566) can be taken, 54 mm for its inner diameter, 7 mm for the rib height, 40 mm for the outer diameter of the surface 550 of the inner tube 542 (without ribs) and 26 mm for the inner diameter of the inner tube 542. The (faint) pitch of the helical line of the ribs 554, see FIG. 14A, may be 185 cm for 360 degrees. The pitch or base helix angle β can be less than 20 degrees, preferably less than 10 degrees, for instance approximately 5 degrees or less. The flanks 556a,b can be at an angle of approximately 30 degrees to the radial through the centre of the rib 554.

In the alternative of FIGS. 14C and 14D largely the same materials and sizes apply. The difference is that the ribs 568 now run parallel to the tube axis (angle β is 0 degrees here) and are increased in number, in order to centre the inner tube 570 and outer tube 572 with respect to each other here as well. In this case three mutually equally large channels are formed in the second passage 574.

The ratio between the flow-through surface 576;560 within the inner tube and the flow-through surface of the annular space 574 can be in the range of approximately 1:1.5 to 1:4.

Considered in cross-section of the inner tube, the ribs 568 can have a starting width (t=the shortest distance between both points where the flanks or sides of the ribs merge into the outer surface of the inner tube) that is larger than the protruding distance of the ribs (the distance measured in radial direction between a line connecting said points with each other and the radial outer tip or surface of the ribs). In that way the starting width can be almost double the protruding distance. In case of said rib height of 7 mm for instance 12 to 14 mm.

In FIG. 15A the situation corresponding with FIG. 8D is shown, wherein the concentric tube assembly 578 that is to form the geothermal heat exchanger 414 is dispensed from a roll 580 in the direction P. The tube assembly 578 can be that of either FIG. 14B or 14D, for instance. As made clear in FIG. 15B an end cap 582 is welded to the lower edge 584a of the outer tube 562. The inner tube 542 ends at some distance above it.

At the lower end of the end cap 582 a narrowed end section 586 is formed, on which with a bolt 588 the upper ends of two upright strips 590a,b of an anchor 592 have been attached. At the lower end of the strips 590a,b an anchor rod 592 is hinged by means of bolt 594, which rod has two equal anchor arms 596a,b that have each been provided with a bevelled anchor tip 598a,b.

During the introduction, see FIG. 15A, the tube assembly is dispensed from a reel 602 in direction P. The drive of the reel 602 provides the required force for the introduction process. The drill tube forces the tube assembly out of a curved condition, that may be the result of the storage on the reel 602, to a stretched shape. The anchor rod 592 with anchor arm 596a is able to rotate (U) within the space left free between the two strips 590a,b, so that a small profile is achieved. The bevelled tip 598b prevents jamming against irregularities in the inner surface of the drill tube 400. When the situation comparable with FIG. 15F is achieved and the drill tube 400 is lifted, too much an upward movement of the lower end 416 of the exchanger 414 is prevented because the anchor tip 598a will tilt, direction V, and will soon engage into the wall of the drill hole, just like tip 598b, all this as indicated in FIG. 15C.

For that matter, also when no anchor is used, the leaving behind of the heat exchanger 414 in the borehole when lifting the drill tube 400 can be enhanced by filling the heat exchanger with water prior to that.

In use, liquid flowing downward (Q) through first passage 552 will turn in the chamber 604 in direction R and then in direction T flow upward in the annular space 506.

After the drill tube 400 has been removed the upper end of the heat exchanger 414, in this example built up with tube assembly 578 of FIGS. 14B; 14D, can be connected to the supply and discharge lines for the heat exchanger liquid. For that purpose use can be made of the splitter cap 608 of FIGS. 16A-E.

Said cap 608, of solid HDPE, comprises a wall 610 that forms a straight through-going third passage 612 and consists of a lower, wide cylindrical portion 614, a conical portion 616 and an upper narrow cylindrical portion 618 that forms a spout 620. Obliquely from the conical portion a spout 622 extends, which forms a fourth passage 624 that is in connection with a third passage 612.

The inner diameter of the third passage in portion 612 almost corresponds with the outer diameter of the outer tube 572, so that it can be fittingly accommodated therein and then be secured by welding.

When arranging the cap 606, first the inner tube 570 is pulled slightly upward (W), which is enhanced when the tube assembly 578 is filled with water. The upper end of the inner tube 572 then extends in the third passage 612. Then a sleeve 628 is inserted in the direction Y into the spout 620. The sleeve 628 has a lower end with thread 630 and an upper flange 632 and forms a passage 634. The sleeve 628 snugly fits in the passage 612 of spout 620. By means of a tool 636 the sleeve with thread 630 is screwed into the inner tube 570 (optionally the first passage of the inner tube is slightly widened for that purpose), until the inner tube 570 with upper end is situated at the level of the lower end of the conical portion 616 and the flange 632 is in the opening edge of the spout 620.

Then the cap 606 with inner tube 570 is pressed downward again, direction Y, FIG. 16C, and the wall section 610 slides over the upper end of the outer tube 572. The outer tube 572 then also extends to the lower end of the conical portion 616, see FIG. 16E. The sleeve 628 is fluid-sealingly accommodated in the spout 620.

Subsequently with the use of adapters the supply and discharge lines 638, 640 are connected, and the various connections are secured by welding.

In FIG. 16E an example of flow direction is given, wherein via line 638, that connects to the sleeve 628, water is supplied in the direction Q and flows through the passage 624 in the first passage 552 of the inner tube 570. At the lower end of the exchanger 414, for instance in a cap 606, the flow turns and the water goes upward through the second passage 574, direction T, and via the inner space of conical portion 614 in the spout 620, flows to discharge line 638.

In FIG. 17 an example of an arrangement for applying a method according to the invention is shown, wherein the device 642 comprises a substructure 644 and a superstructure 646 with an outrigger 648 thereon for a supply roll 650 of heat exchanger 414. The superstructure 646 also bears a mast 652, that is provided with a guide 654 for a drill motor 656, with which the tube 400 can be introduced into the soil and also be removed from it again. At this stage the condition of FIG. 15C is achieved and the heat exchanger is inserted in the direction E. This is possible by using the drive of a reel on which a storage length of heat exchanger tube is stored and supplied, see FIG. 15A or, if necessary, using an extra introduction device, such as the device 642 attached on the tube 400.

In FIGS. 18A and 18B is an example of a guiding device or pressure/pusher device 658 is shown which is to be attached to the upper end of the inserted tube 400, with which device a heat exchanger 414 can be pressed into the inside of the tube 400, direction E. The device 658 comprises a length of tube 660, which at the top is provided with a sleeve 662 in which a rubber sealing packing seal 664 is attached that engages in the heat exchanger 414 to be introduced. At the outer side of the length of tube 660 three arms 666a,b (not shown in FIG. 18A, in FIG. 18B the arms 666,668 and 670) are attached, of which only the arm 676 is tiltable about pin 672 in the directions N. Above the sleeve 662 the arms have each been provided with a wheel or roller 678, that can only be rotated in the indicated directions. The rollers 678, considered in circumferential direction, are at 120 degrees to each other.

In operation the device 658 is clamping-fixedly attached to the upper end of the tube 400 by means of adjustable clamping pins 680, with fixed alignment with respect to the tube 400. Subsequently the leading end of the heat exchanger 414 is taken to the rollers 678, and by means of adjusting pin 682, the outer end 684 of which supports against the length of tube, the position of the roller 678 on the arm 676 is adjusted in the direction O, in order to realise the desired engagement of the rollers 678 onto the heat exchanger 414. Due to the adjustment a correct position of the heat exchanger 414 with respect to the cross-section of the tube 400 is promoted.

The device 658 can be used as guide, for instance when use is made of a reciprocally movable pressure/pressure device, for instance arranged on the drill motor. Alternatively one or more of the rollers 678 can be driven, see device 658 in FIG. 14B, in which the roller 678 on the fixed arm 666 is driven by a motor attached on the arm 666. In that case a further pressure/pusher device can be dispensed with.

With the invention an as small as possible borehole can be required. The invention can be carried out in all soil types. In loose, particularly granular soil types the borehole will not subside.

The above description is included to illustrate the operation of preferred embodiments of the invention and not to limit the scope of the invention. Starting from the above explanation many variations that fall within the spirit and scope of the present invention will be evident to an expert.

What is claimed is:

1-109. (canceled)

110. A geothermal heat exchanger, comprising:
an inner tube bounding a first passage for a flowing heat exchanger fluid and having one or more ribs on an outer side thereof, the inner tube and the one or more ribs integrally formed by extrusion and entirely made of a thermally-insulating synthetic foamed material; and
an outer tube made of thermally-conductive material concentrically positioned around the inner tube such that the one or more ribs abut a first surface of the outer tube, and the inner tube and the outer tube cooperate to define an annular space which forms a second passage for the flowing heat exchanger fluid.

111. The geothermal heat exchanger of claim 110, wherein the inner tube has a plurality of ribs, the plurality of ribs keeping the inner tube centred within the outer tube and keeping the inner tube and outer tube thermally insulated from each other.

112. The geothermal heat exchanger of claim 110, wherein the inner tube has a plurality of ribs, the plurality of ribs dividing the second passage into parallel channels.

113. The geothermal heat exchanger of claim 110, wherein the one or more ribs extend substantially continuously, considered in a main direction of the inner tube.

114. The geothermal heat exchanger of claim 113, wherein the inner tube has an axis, and wherein three or more ribs extend parallel to the inner tube axis, and, considered in cross-section of the inner tube, the three or more ribs are distributed regularly over a circumference of the inner tube.

115. The geothermal heat exchanger of claim 113, wherein the one or more ribs extend according to a helical line.

116. The geothermal heat exchanger of claim 115, comprising two ribs, wherein the pitch of the helical line of the two ribs is 360 degrees per at least approximately 1 m.

117. The geothermal heat exchanger of claim 116, wherein the pitch of the helical line of the two ribs is 360 degrees per more than approximately 1.5 m.

118. The geothermal heat exchanger of claim 110, wherein the thermally insulating material of the inner tube and the one or more ribs is a synthetic foamed material with closed cells.

119. The geothermal heat exchanger of claim 118, wherein the thermally insulating material of the inner tube and the one or more ribs is HDPE.

120. The geothermal heat exchanger of claim 110, wherein the ratio between a flow-through surface inside the inner tube and a flow-through surface of the annular space is in the range of between approximately 1 to 1.5 and approximately 1 to 4.

121. The geothermal heat exchanger of claim 110, wherein the one or more ribs, considered in cross-section of the inner tube, have a starting width being the shortest distance between points where flanks of the one or more ribs merge into an outer surface of the inner tube, which width is larger than a protruding distance of the one or more ribs, the protruding distance being the distance measured in radial direction between a line connecting said points with each other and a radial outer tip of the one or more ribs.

122. The geothermal heat exchanger of claim 110, wherein the one or more ribs, considered in cross-section, have flanks converging in radial outward direction, the flanks defining a substantially trapezoidal cross-section of the one or more ribs.

123. The geothermal heat exchanger of claim 110, wherein the outer tube is made of a heat-conducting solid synthetic material.

124. The geothermal heat exchanger of claim 123, wherein the outer tube is made of solid HDPE.

125. The geothermal heat exchanger of claim 110, further comprising a distal end, wherein the distal end is provided with an end cap which forms a turning means for the flowing heat exchanger fluid between the first passage and the second passage.

126. An arrangement of at least one geothermal heat exchanger according to claim 125, arranged in a bottom, wherein the at least one geothermal heat exchanger extends in a borehole in the bottom, wherein the at least one geothermal heat exchanger at an upper end is connected to a thermal converter while creating a flow cycle for a heat exchanging liquid in which the first and second passages and the thermal converter are included.

127. A tube, comprising an extruded casing of thermally-insulating synthetic foamed material, wherein an outer side of the casing is provided with at least one helical rib of thermally-insulating synthetic foamed material, the at least one helical rib formed as a unitary body with the extruded casing.

128. The tube of claim 127, further comprising an outer tube made of thermally conductive material, wherein the extruded casing is accommodated in the outer tube in a concentric manner, and the outer tube is supported by the at least one helical rib.

129. The tube of claim 127, wherein the extruded casing is arranged around a tube of substantially solid material in a snugly fitting manner.

130. A method for manufacturing a casing provided with at least one helical rib on its outer side, comprising:
extruding the casing and the at least one helical rib simultaneously from the same foamed synthetic material with closed cells; and
wherein the surface of the foamed synthetic material of the casing and the at least one helical rib are closed and made smooth in the extrusion process.

131. The method of claim 130, further comprising:
inserting the casing in an outer tube of a thermally conductive material; and
storing the casing and the outer tube on a roll.
